(19) United States
(12) Patent Application Publication
(10) Pub. No.: US 2007/0184393 A1
(43) Pub. Date: Aug. 9, 2007

(54) Image Forming Method, Liquid Developer Developing Apparatus, and Image Forming Apparatus

(75) Inventors: Satoru MIURA, Matsumoto-shi (JP); Hiroshi KAIHO, Matsumoto-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/671,990

(22) Filed: Feb. 6, 2007

(30) Foreign Application Priority Data
Feb. 7, 2006 (JP) 2006-030100
Oct. 27, 2006 (JP) 2006-293301

(51) Int. Cl. G03C 5/00

(52) U.S. Cl. 430/331

(57) ABSTRACT

An image forming method using liquid developers is provided. The method includes a developing step for forming a plurality of monochromatic color images using a plurality of liquid developers of different colors; a transfer step for transferring a plurality of monochromatic color images which correspond to the respective different colors onto a recording medium to form an unfixed color image onto the recording medium; and a fixing step for fixing the unfixed color image onto the recording medium, wherein each of the liquid developers is comprised of an insulation liquid containing an unsaturated fatty acid component and toner particles dispersed in the insulation liquid, and wherein the liquid developers include a magenta liquid developer, and the magenta liquid developer contains an oxidation polymerization accelerator which accelerates an oxidation polymerization reaction of the unsaturated fatty acid component in the fixing step. A liquid developer developing apparatus and an image forming apparatus using the image forming method are also provided.

### CROSS-REFERENCE TO RELATED APPLICATION

This application claims priorities to Japanese Patent Applications No. 2006-030100 filed on Feb. 7, 2006 and No. 2006-293301 filed on Oct. 27, 2006 which are hereby expressly incorporated by reference herein in their entireties.

### BACKGROUND OF THE INVENTION

1. Field of the Invention

The present invention relates to an image forming method, a liquid developer developing apparatus, and an image forming apparatus, and more specifically relates to an image forming method using liquid developers, a liquid developer developing apparatus for carrying out the image forming method, and an image forming apparatus equipped with the liquid developer developing apparatus.

2. Description of the Related Art

Conventionally, as a method of forming an image on a recording medium, there is known a method using a plurality of liquid developers each comprised of an insulation liquid and toner particles dispersed in the insulation liquid.

In the image forming method using the liquid developers, since aggregation of toner particles in the liquid developers is effectively prevented as compared to a method using dry toners, it is possible to use very fine toner particles and it is also possible to use a binder resin having a low softening point (a low softening temperature). As a result, the method using the liquid developers has such advantages as good reproductivity of an image composed of thin lines, good tone reproductivity as well as good reproductivity of colors.

As for the insulation liquid used in the liquid developers, petroleum carbon hydride, silicone oil, and the like are generally used due to their high chemical stability.

However, the method using the liquid developers involves a problem in that the insulation liquid adhering to the surfaces of the toner particles are likely to be impregnated into a recording medium when the toner particles are to be fixed, which results in lowered fixing strength of the toner particles. Further, there is also a problem in that such impregnation of the liquid developer into the recording medium makes it difficult to write letters or symbols on the recoding medium with a ball paint pen.

In order to solve such problems as described above, it is attempted that a plant-derived natural oil is used as an insulation liquid and an oxidation polymerization reaction of the oil is utilized for fixing toner particles. One example of such a method is disclosed in JP A No. 2000-162829.

In the method disclosed in JP A No. 2000-162829, an oxidation polymerization accelerator comprised of fatty acid metallic salts and the like which accelerates oxidation polymerization is used in order to improve the fixing properties. However, use of such an oxidation polymerization accelerator lowers colors of an image obtained, and thus there is problem in that such an oxidation polymerization accelerator cannot be suitably used for forming a color image.

### SUMMARY

It is therefore a main object of the present invention to provide an image forming method which is harmless to environment and can fix toner particles onto a recording medium firmly while preventing a quality of an obtained color image from being lowered. Further, another object of the present invention is to provide a liquid developer developing apparatus using the image forming method, and an image forming apparatus equipped with the liquid developer developing apparatus.

In order to achieve the main object, the present invention is directed to an image forming method. The method comprises: a developing step for forming a plurality of monochromatic color images using a plurality of liquid developers of different colors; a transfer step for forming an unfixed color image onto a recording medium; and a fixing step for fixing the unfixed color image onto the recording medium, wherein each of the liquid developers is comprised of an insulation liquid containing an unsaturated fatty acid component and toner particles dispersed in the insulation liquid, and wherein the liquid developers include a magenta liquid developer, and the magenta liquid developer contains an oxidation polymerization accelerator which accelerates an oxidation polymerization reaction of the unsaturated fatty acid component in the fixing step.

In the image forming method according to the present invention, it is preferred that the oxidation polymerization accelerator is colored with red or its similar colors.

Further, it is also preferred that the liquid developers further include a black liquid developer, a yellow liquid developer and a cyan liquid developer, wherein among the magenta, yellow and cyan liquid developers only the magenta liquid developer contains the oxidation polymerization accelerator.

Further, it is also preferred that the liquid developers further include a black liquid developer, a yellow liquid developer and a cyan liquid developer, wherein the yellow liquid developer and the cyan liquid developer also contain the oxidation polymerization accelerator, but the magenta liquid developer contains a largest amount of the oxidation polymerization accelerator.

In the method mentioned above, it is preferred that the amount of the oxidation polymerization accelerator contained in the magenta liquid developer with respect to 100 parts by weight of the insulation liquid is defined as X parts by weight and the amount of the oxidation polymerization accelerator contained in the yellow liquid developer with respect to 100 parts by weight of the insulation liquid is defined as Y parts by weight, the relation of Y/X≦0.1 is satisfied.

Further, it is also preferred that when the amount of the oxidation polymerization accelerator contained in the magenta liquid developer with respect to 100 parts by weight of the insulation liquid is defined as X parts by weight and the amount of the oxidation polymerization accelerator contained in the cyan liquid developer with respect to 100 parts by weight of the insulation liquid is defined as Z parts by weight, the relation of Z/X≦0.4 is satisfied.

In the image forming method according to the present invention, it is also preferred that the amount of the oxidation polymerization accelerator contained in the magenta liquid developer with respect to 100 parts by weight of the insulation liquid is in the range of 0.01 to 2 parts by weight.

Further, it is also preferred that the insulation liquid contains unsaturated fatty acid glyceride and fatty acid monoester.

Furthermore, it is also preferred that the oxidation polymerization accelerator is contained in the liquid developer with being encapsulated.

Another aspect of the present invention is directed to a liquid developer developing apparatus. The apparatus comprises: a plurality of developing sections for forming a plurality of monochromatic color images using a plurality of liquid developers of different colors; an intermediate transfer section to which the plurality of monochromatic color images are sequentially transferred to form an intermediate transfer image which is formed by overlaying the transferred monochromatic color images one after another; and a secondary transfer section for transferring the intermediate transfer image onto a recording medium to form an unfixed image, wherein each of the liquid developers of the different colors is comprised of an insulation liquid containing an unsaturated fatty acid component and toner particles dispersed in the insulation liquid, and wherein the liquid developers include a magenta liquid developer, and the magenta liquid developer contains an oxidation polymerization accelerator which accelerates an oxidation polymerization reaction of the unsaturated fatty acid component when the transferred imaged is fixed.

In the liquid developer developing apparatus mentioned above, it is preferred that the plurality of developing sections are composed from a developing section for forming a black monochromatic image and a plurality of color developing sections for forming the plurality of monochromatic color images other than black, wherein among these color developing sections for forming the monochromatic color images the color developing section including the magenta liquid developer is arranged at a position from which the monochromatic color image is formed on the intermediate transfer section at the last.

Further, in the liquid developer developing apparatus mentioned above, it is preferred that each of the developing sections includes a liquid developer storage for containing the corresponding liquid developer, and the liquid developer storage containing the magenta liquid developer includes a reducing element for reducing the unsaturated fatty acid component which has been oxidized, in which the reducing element is formed of zeolite.

Still another aspect of the present invention is directed to an image forming apparatus. The image forming apparatus comprises: a plurality of developing sections for forming a plurality of monochromatic color images using a plurality of liquid developers of different colors; an intermediate transfer section to which a plurality of monochromatic color images formed by the developing sections are sequentially transferred to form an intermediate transfer image which is formed by overlaying the transferred monochromatic color images one after another; a secondary transfer section for transferring the intermediate transfer image onto a recording medium to form an unfixed image onto the recording medium, and a fixing device for fixing the unfixed image onto the recording medium, wherein each of the liquid developers of the different colors is comprised of an insulation liquid containing an unsaturated fatty acid component and toner particles dispersed in the insulation liquid, and wherein the liquid developers include a magenta liquid developer, and the magenta liquid developer contains an oxidation polymerization accelerator which accelerates an oxidation polymerization reaction of the unsaturated fatty acid component when the transferred imaged is fixed.

According to the image forming method mentioned above, it is possible to provide an image forming method which is harmless to environment and can fix toner particles onto a recording medium firmly while preventing a quality of an obtained color image from being lowered.

These and other objects, structures and advantages of the present invention will be more apparent when the following detailed description of the preferred embodiments and the examples will be considered taken in conjunction with the appended drawings.

### BRIEF DESCRIPTION OF THE DRAWINGS

FIG. 1 is an illustration which shows one example of an image forming apparatus according to the present invention.

FIG. 2 is a schematic view which shows one example of a developing unit provided in a liquid developer developing apparatus according to the present invention.

FIG. 3 is a cross-sectional view which shows one example of a fixing unit provided in an image forming apparatus according to the present invention.

### DETAILED DESCRIPTION OF THE PREFERRED EMBODIMENTS

Hereinbelow, a detailed description will be made with regard to preferred embodiments of an image forming method, a liquid developer developing apparatus and an image forming apparatus according to the present invention.

### First Embodiment

### First Embodiment of Image Forming Method

Hereinbelow, the first embodiment of the image forming method according to the present invention will be described.

The image forming method of this embodiment includes a developing step for forming a plurality of monochromatic color images using a plurality of liquid developers of different colors; a transfer step for forming an unfixed color image onto a recording medium; and a fixing step for fixing the unfixed color image onto the recording medium.

Further, in the image forming method of this embodiment, as the liquid developers, a black liquid developer and a plurality of color liquid developers having different colors other than black are used. Each of the liquid developer is comprised of an insulation liquid containing an unsaturated fatty acid component and toner particles dispersed in the insulation liquid.

(Liquid Developers)

Hereinbelow, a description will be made with regard to liquid developers that can be used for the image forming method (the liquid developer developing apparatus and the image forming apparatus) according to the present invention.

1. Insulation Liquid

First, a description will be made with regard to the insulation liquid.

The insulation liquid which constitutes each liquid developer according to the present invention contains as its main component an unsaturated fatty acid component having unsaturated bonds.

The unsaturated fatty acid component is a substance which is harmless to environment. Therefore, it is possible to reduce an adverse affect to environment caused by volatilization of the insulation liquid when it is used during the fixing process or disposal of the liquid developers. As a result, it is possible to provide liquid developers harmless to environment.

The unsaturated fatty acid component is a component which is oxidized and polymerized by a heat or the like applied during the fixing process. Namely, the unsaturated fatty acid component itself is a component which is cured due to an oxidation polymerization reaction to exhibit a function of improving the fixing properties of the toner particles. In particular, by using an oxidation polymerization accelerator (which will be described later in detail), it is possible to accelerate an oxidation polymerization reaction of the unsaturated fatty acid component to thereby enables the toner particles to be fixed firmly onto a recording medium in a short time. Furthermore, since the unsaturated fatty acid component is cured, it is possible to write letters or the like onto the fixed toner image with a ballpoint pen using a water-based ink easily and reliably.

Further, the unsaturated fatty acid component has a higher compatibility with toner particles (a resin material constituting the toner particles). Therefore, by using an insulation liquid containing an unsaturated fatty acid component like the present invention, it is possible to improve dispersibility of the toner particles. As a result, it is possible to avoid occurrence of settle down and aggregation of the toner particles during the preservation effectively.

Examples of the unsaturated fatty acid which can constitute the unsaturated fatty acid component of the present invention include monounsaturated fatty acids such as oleic acid, palmitoleic acid, and recinoleic acid, polyunsaturated fatty acids such as linoleic acid, α-linolenic acid, γ-linolenic acid, arachidonic acid, docosahexaenoic acid (DHA) and eicosapentaenoic acid (EPA) and the like. These unsaturated fatty acids can be used singly or in combination of two or more of them.

Among the unsaturated fatty acid components mentioned above, polyunsaturated fatty acids are preferably used. Further, among such polyunsaturated fatty acids, polyunsaturated fatty acids having conjugated unsaturated bonds (conjugated unsaturated fatty acid components) are preferably used.

As such conjugated unsaturated fatty acid components, various types can be used if they have conjugated unsaturated bonds. For example, those obtained by synthesis, obtained by direct extraction from plant oils or the like, and obtained by conjugation of unsaturated fatty acid components may be used.

Such unsaturated fatty acids can be obtained effectively from naturally derived oils such as vegetable oils, animal oils and the like. Examples of the vegetable oils include dehydrated ricinus oil, wood oil, safflower oil, linseed oil, sunflower oil, corn oil, cottonseed oil, soybean oil, sesame oil, hemp oil, evening primrose oil, blackcurrant oil, borage oil, and the like, and examples of the animal oils include chub mackerel oil, herring oil, sardine oil, and the like.

Among these oils, dehydrated ricinus oil is preferably used since it contains a large amount of a conjugated linoleic acid component (conjugated unsaturated fatty acid component). Use of such a dehydrated ricinus oil makes it possible to promote an oxidation polymerization reaction effectively. As a result, it is possible to fix a toner image firmly.

The ratio of the amount of the unsaturated fatty acid component with respect to the all fatty acid components contained in the insulation liquid is not limited to a specific value, but it is preferably 10 mol % or more, more preferably 20 mol % or more, and even more preferably in the range of 20 to 90 mol %. This makes it possible to progress the oxidation polymerization reaction more effectively during the fixing process.

In the insulation liquid, the unsaturated fatty acid component may be existed in any forms. For example, the unsaturated fatty acid component may be existed in the form of unsaturated fatty acid (unsaturated fatty acid salts), or in the form of a compound obtained by bonding with other components. Examples of such a compound include ester of an unsaturated fatty acid component and an alcohol component (poly-alcohol) and amide of an unsaturated fatty acid component and an amine component (polyamine), and the like. Among these compounds, ester is particularly preferable, and ester of glycerine and an unsaturated fatty acid component (hereinafter, referred to as “unsaturated fatty acid glyceride”) is more preferable. In the case where such ester as described above is existed in the insulation liquid, preservability and storage stability of the liquid developer can be made excellent. Further, fixing properties of toner particles onto a recording medium can also be made excellent.

Further, in addition to the above components, the insulation liquid may contain saturated fatty acid components such as follows.

Saturated fatty acid components are components having the function of maintaining the chemical stability of the liquid developer at a higher level. Therefore, when the insulation liquid contains such saturated fatty acid components, it is possible to prevent chemical changes from occurring in the liquid developer effectively. As a result, preservability and storage stability of the liquid developer obtained can be made more excellent.

Further, the saturated fatty acid components also have the function of keeping excellent electrical insulation property and viscosity of the liquid developer. Therefore, when the insulation liquid contains a predetermined amount of the saturated fatty acid components, it is possible to maintain high electric resistance of the liquid developer. Further, it is also possible to make transport property of the liquid developer excellent by controlling the viscosity thereof.

Examples of saturated fatty acids constituting such saturated fatty acid components include butyric acid (C4), caproic acid (C6), caprylic acid (C8), capric acid (C10), lauric acid (C12), myristic acid (C14), palmitic acid (C16), stearin acid (C18), arachic acid (C20), behenic acid (C22), lignocerin acid (C24) and the like. These acids can be used singly or in combination of two or more of them. Among these saturated fatty acids, it is preferred to use one in which carbon number within a molecule is in the range of 6 to 22, more preferred to use one in which carbon number within a molecule is in the range of 8 to 20, and even more preferred to use one in which carbon number within a molecule is in the range of 10 to 18. By containing saturated fatty acid components composed of such saturated fatty acids in the insulation liquid, the above-mentioned effects can be exhibited more remarkably.

The above-mentioned saturated fatty acid components can be obtained effectively from naturally derived oils such as vegetable oils (e.g. palm oil (especially palm kernel oil), coconut oil, cocoanut oil), animal oils (e.g. butter) and the like.

The ratio of the amount of the saturated fatty acid components with respect to the all fatty acid components contained in the insulation liquid is not limited to a specific value, but it is preferably in the range of 0.5 to 40 mol %, and more preferably in the range of 1 to 30 mol %. This makes it possible to keep the electrical insulation property of the insulation liquid at a higher level as well as progress the oxidation polymerization reaction more effectively during the fixing process.

In the case where the insulation liquid contains both the unsaturated fatty acid components and the saturated fatty acid components, the unsaturated fatty acid components and the saturated fatty acid components may be existed in any forms in the insulation liquid. For example, in the insulation liquid. the unsaturated fatty acid components and the saturated fatty acid components may be existed independently in the forms of unsaturated fatty acid (unsaturated fatty acid salts) and saturated fatty acid (saturated fatty acid salts) respectively, or in the forms of compounds obtained by bonding with other components. Examples of such compounds include ester of an unsaturated fatty acid component and/or a saturated fatty acid component and an alcohol component (poly-alcohol), amide of an unsaturated fatty acid component and/or a saturated fatty acid and an amine component (polyamine), and the like. Among these compounds, ester is particularly preferable, and ester of glycerine and an unsaturated fatty acid component and/or a saturated fatty acid component (hereinafter, referred to as “glyceride”) are more preferable.

Further, in addition to the above-mentioned components, the insulation liquid may contain, for example, fatty acid monoester such as follows.

The fatty acid monoester is ester of fatty acid and monohydroxy alcohol. Since the fatty acid monoester has properties of low molecule and low viscosity, it is impregnated into resin particles (toner particles) to exhibit a plasticizing effect during the fixing process. Due to this plasticizing effect, when a paper is used as a recording medium, toner particles can easily enter into gaps between paper fibers. This makes it possible to make fixing strength of the toner particles higher as well as to accomplish fixation of the toner particles at a relatively low temperature. Further, such entering of the toner particle into the gaps of the fibers also makes it possible to obtain a color image having a smooth surface with no irregularities. As a result, the formed color image can have excellent glaze (gloss).

Further, due to the plasticizing effect described above, toner particles corresponding to the respective colors are suitably mixed to thereby form a color image having a desired color tone appropriately.

In particular, in the case where a polyester resin is used as a resin material for constituting the toner particles, the plasticizing effect described above is exhibited conspicuously. As a result, it is possible to make fixing strength of the toner particles higher and form a color image having excellent color tone.

Further, since fatty acid monoester is a component which is easily impregnated into the recording medium, fatty acid monoester adhering to the surfaces of the toner particles is easily impregnated into a recording medium when the toner particles make contact with the recording medium during the fixing process. Further, since a part of each toner particle (that is, a resin material constituting the toner particles) which has been fused by heat upon fixation is also impregnated into the recording medium together with the fatty acid ester, an anchoring effect is created to thereby further enhance the fixing strength of the toner particles. Furthermore, since a part of unsaturated fatty acid glyceride existing in the vicinity of the surface of each toner particle is also impregnated into the recording medium together with the fatty acid monoester and they are oxidized and polymerized in such a state, the toner particles are fixed onto the recording medium more firmly.

Moreover, since the fatty acid monoester is a component which is harmless to environment, it is possible to decrease a load to the environment by the insulation liquid which may be cased by leakage of the insulation liquid out of the image forming apparatus and discard of the used liquid developers. As a result, it is possible to provide an image forming apparatus which is harmless to the environment.

The amount of the fatty acid monoester contained in the insulation liquid is preferably in the range of 5 to 55 wt %, more preferably in the range of 10 to 50 wt %, and even more preferably in the range of 20 to 50 wt %. If the amount of the fatty acid monoester is within the above range, impregnability of the insulation liquid into a recording medium can be made higher. Further, the plasticizing effect described above can also be exhibited sufficiently. With these results, it is possible to fix the toner particles more firmly and form a color image having excellent color tone.

No particular limitation is imposed on the kinds of the fatty acid monoester that can be used in the liquid developer of the present invention. Examples of such fatty acid monoester include unsaturated fatty acid alkyl monoester, saturated fatty acid alkyl monoester, and the like. Here, “alkyl” includes methyl, ethyl, propyl, butyl, and the like. These fatty acid monoesters can be used singly or in combination of two or more of them.

In this regard, examples of the unsaturated fatty acid include oleic acid, palmitoleic acid, recinoleic acid, linoleic acid, α-linolenic acid, γ-linolenic acid, arachidonic acid, docosahexaenoic acid (DHA), eicosapentaenoic acid (EPA), and the like. On the other hand, examples of the saturated fatty acid include butyric acid, caproic acid, caprylic acod, capric acid, lauric acid, myristic acid, palmitic acid, stearic acid, arachidic acid, behenic acid, lignoceric acid, and the like.

As for such fatty acid monoester, it is preferred to use unsaturated fatty acid monoester having an unsaturated fatty acid component as its fatty acid component. The unsaturated fatty acid component is a component that can contribute to improving fixing properties of toner particles against a recording medium.

More specifically, unsaturated fatty acid monoester itself is cured during the fixing process due to its oxidation polymerization, and therefore it is possible to especially enhance the fixing strength of the toner particles onto the recording medium. As a result, since not only unsaturated fatty acid glyceride being impregnated into the recording medium, but also unsaturated fatty acid monoester can contribute to the oxidation polymerization, the especially excellent fixing strength can be obtained.

The amount of the unsaturated fatty acid monoester contained in all the fatty acid components of the fatty acid monoester is preferably 50 mol % or more, and more preferably 60 mol % or more. With this result, the above described effects can be exhibited more reliably and therefore especially high fixing strength can be obtained.

Further, it is preferred that the fatty acid component of the fatty acid monoester is mainly comprised of unsaturated fatty acid, but it may contain saturated fatty acid as a part thereof. This makes it possible to further improve preservability and storage stability of the insulation liquid.

The fatty acid monoester is ester of fatty acid and monohydroxy alcohol, wherein preferably the alcohol is alkyl alcohol having a carbon number of 1 to 4. By using such ester, chemical stability of the liquid developer can be made excellent and preservability and storage stability of the insulation liquid can also be made more excellent. Further, this also makes it possible to set the viscosity of the insulation liquid appropriately so that the liquid developer can be impregnated into a recording medium suitably. Examples of such alcohol include methanol, ethanol, propanol, butanol, isobutanol, and the like.

In this regard, it is more preferable that the fatty acid monoester which constitutes the insulation liquid is one obtained by an ester exchange reaction of fatty acid glyceride and monohydroxy alcohol having a carbon number of 1 to 4. By using such fatty acid monoester, it is possible to increase compatibility between the fatty acid monoester and the fatty acid glyceride further, and therefore the viscosity of the insulation liquid is set more appropriately so that the liquid developer can be impregnated into a recording medium more suitably. As a result, since fixing strength of toner particles against a recording medium can be made excellent, a liquid developer containing such an insulation liquid can be preferably used for image formation at a high speed.

In the case where the insulation liquid is comprised of the unsaturated fatty acid glyceride and the fatty acid monoester as described above, when the amount of the unsaturated fatty acid glyceride contained in the insulation liquid is defined as A [wt %] and the amount of the fatty acid monoester contained in the insulation liquid is defined as B [wt %], it is preferred that the relation of 0.1≦A/B≦9 is satisfied, more preferably the relation of 0.4≦A/B≦9 is satisfied, and even more preferably the relation of 0.6≦A/B≦9 is satisfied. By satisfying such relationship, the viscosity of the insulation liquid can be set more appropriately so that the liquid developer can be impregnated into a recording medium more suitably. As a result, the anchoring effect caused by the curing of the unsaturated fatty acid component described above can be exhibited conspicuously to thereby obtain especially excellent fixing strength of the toner particles against a recording medium. Further, since the plasticizing effect described above can also be exhibited conspicuously, a color image to be formed can have excellent glaze (gloss).

Further, in the case where the insulation liquid is comprised of the unsaturated fatty acid glyceride and the fatty acid monoester as described above, the amount of the unsaturated fatty acid glyceride contained in the insulation liquid is preferably in the range of 20 to 90 wt %, and more preferably in the range of 40 to 90wt %.

Furthermore, in the case where the insulation liquid is comprised of the unsaturated fatty acid glyceride and the fatty acid monoester as described above, the amount of the fatty acid monoester contained in the insulation liquid is preferably in the range of 10 to 80 wt %, and more preferably in the range of 10 to 60 wt %.

In this connection, it is to be noted that the liquid developer (insulation liquid) may further contain an antioxidizing agent having the function of preventing or suppressing oxidation of the insulation liquid. This makes it possible to prevent unwilling oxidation of the unsaturated fatty acid component.

Examples of such an antioxidizing agent include vitamin E such as tocopherol, d-tocopherol, d1-α-tocopherol, acetic acid-α-tocopherol, acetic acid d1-α-tocopherol, tocopherol acetate, and α-tocopherol, vitamin C such as ascorbic acid, ascorbic acid salts (ascorbate), ascorbate stearic acid ester, dibutyl hydroxy toluene, butyl hydroxy anisole, green tea extract, green coffee bean extract, sesamol, sesaminol, and the like. These antioxidizing agents may be used singly or in combination with two or more of them.

Among these substances, when a vitamin E is used, it is possible to obtain the following effects. Namely, a vitamin E is a substance which is harmless to environment, and its oxidative product produced by oxidation thereof gives only small affects to the liquid developer. Further, since a vitamin E is a substance having high dispersibility to a liquid containing the unsaturated fatty acid component (in particular, glyceride) as described above, it can be used as the antioxidizing agent preferably. Furthermore, by using a vitamin E together with the unsaturated fatty acid glyceride described above, it is possible to further improve compatibility of a toner material with the insulation liquid. As a result, it is possible to make the preservability of the liquid developer and the fixing property of the toner particles against a recoding medium especially excellent.

Further, among the substances mentioned above, when a vitamin C is used, it is possible to obtain the following effects. Namely, as is the same with the vitamin E described above, a vitamin C is a substance which is harmless to environment, and its oxidative product produced by oxidation thereof gives only small affects to the liquid developer. Further, since a vitamin C is a substance having a relatively low pyrolysis temperature, it can exhibit a function as the antioxidizing agent sufficiently during the storage or preservation of the liquid developer and at the time of an idling of an image forming apparatus while the function as the antioxidizing agent is lowered during the fixing process so that the oxidation polymerization reaction of the insulation liquid can be progressed reliably.

It is preferred that the pyrolysis temperature of the antioxidizing agent is lower than the fixing temperature during the fixing process. This makes it possible to prevent deterioration of the insulation liquid during the storage or preservation of the liquid developer more reliably. Further, the antioxidizing agent contained in the insulation liquid and adhering to the surfaces of the toner particles is thermally decomposed during the fixing process, so that it is possible to cure (oxidation polymerization reaction) the insulation liquid effectively, thereby enabling the fixing strength of the toner particles against a recording medium to be made sufficiently excellent.

The pyrolysis temperature of the antioxidizing agent is preferably 200° C. or lower, and more preferably 180° C. or lower. This makes it possible to enhance the fixing strength of the toner particles effectively while keeping the function as the antioxidizing agent sufficiently.

The electric resistance of the insulation liquid at room temperature (20° C.) described above is preferably equal to or higher than 1×10⁹ Ωcm , more preferably equal to or higher than 1×10¹¹ Ωcm, and even more preferably equal to or higher than 1×10¹³ Ωcm.

Further, the dielectric constant of the insulation liquid is preferably equal to or lower than 3.5.

2. Oxidation Polymerization Accelerator

In this embodiment, the liquid developers having different colors other than black include a magenta liquid (liquid developer for magenta) developer, and the magenta liquid developer contains an oxidation polymerization accelerator (curing accelerator) which accelerates or promotes an oxidation polymerization reaction (curing reaction) of the unsaturated fatty acid component during the fixing process, wherein the oxidation polymerization accelerator is colored with red or its similar colors.

In the meantime, generally, oxidation polymerization accelerators themselves are colored with brown or its similar colors. Therefore, normally, if such an oxidation polymerization accelerator is used in a color image development, there is a problem in that a color of an obtained image is deteriorated due to the color presented by the oxidation polymerization accelerator.

On the other hand, in the case where an oxidation polymerization accelerator which is colored with red or its similar colors is contained in a magenta liquid developer like this embodiment, toner particles can be fixed onto a recording medium firmly while preventing an image quality of an obtained image from being lowered. This is supposed to be resulted from fact that magenta is a color which is similar to the color of the oxidation polymerization accelerator, that is, red or its similar colors, and magenta is a relatively deep color among other colors other than black, thereby enabling the affect from the color of the oxidation polymerization accelerator to be made small.

Further, in the case where the oxidation polymerization accelerator is contained in the liquid developer, it is preferred that the liquid developer be of the type that (but not limited thereto) does not contribute to an oxidation polymerization reaction of the unsaturated fatty acid component during the storage or preservation of the liquid developer (including at the time of an idling of an image forming apparatus) while contributes to an oxidation polymerization reaction (curing) of the unsaturated fatty acid component during the fixing process.

Furthermore, as for such an oxidation polymerization accelerator, it is possible to use, for example, a substance which has a function that can promote the oxidation polymerization reaction (curing reaction) under heated conditions while does not have a function that can promote the oxidation polymerization reaction (curing reaction) at or around room temperature, that is, a substance having a relatively high activation energy in the oxidation polymerization reaction (curing reaction) of the unsaturated fatty acid component.

Examples of such an oxidation polymerization accelerator having red or its similar colors and satisfying the above conditions include fatty acid metallic salts such as cobalt naphthenate, manganese naphthenate, manganese octylic acid, and the like. These can be used singly or in a combination of two or more of them.

The oxidation polymerization accelerator may be contained in the insulation liquid with being encapsulated. By using such encapsulated oxidation polymerization accelerator, likewise the above, it is possible to provide a liquid developer substantially be of the type that does not contribute to an oxidation polymerization reaction of the unsaturated fatty acid component during the idling of the image forming apparatus and the like while contributes to an oxidation polymerization reaction (curing) of the unsaturated fatty acid component during the fixing process. Namely, it is possible to prevent an oxidation polymerization reaction from being caused during the storage or preservation of the liquid developer more reliably. Further, since the capsules of the oxidation polymerization accelerator are collapsed with a predetermined pressure applied at the fixing process to make contact between the oxidation polymerization accelerator and the insulation liquid, it is possible to progress the oxidation polymerization reaction of the insulation liquid reliably. Furthermore, such encapsulation widens selection of materials that can be used as the oxidation polymerization accelerator. In other words, even in the case where an oxidation polymerization accelerator has a high reactivity (that is, an oxidation polymerization accelerator that contributes to an oxidation polymerization reaction of the insulation liquid at a relatively low temperature), it can be used appropriately, thereby enabling fixing strength of the toner particles against a recording medium to be made more excellent.

In this regard, it is to be noted that encapsulation of the oxidation polymerization accelerator may be carried out as follows, for example.

First, an oxidation polymerization accelerator is prepared.

Then, the thus prepared oxidation polymerization accelerator is dissolved in a solvent.

Various solvents can be used if they can dissolve the oxidation polymerization accelerator. Examples of such solvents include, but not limited thereto, inorganic solvents such as carbon disulfide, and carbon tetrachloride, and organic solvents such as ketone-based solvents (e.g., methyl ethyl ketone (MEK), methyl isopropyl ketone (MIPK), and 2-heptanone), alcohol-based solvents (e.g., pentanol, n-hexanol, 1-octanol, and 2-octanol), ether-based solvents (e.g., diethyl ether, and anisole), aliphatic hydrocarbon-based solvents (e.g., hexane, pentane, heptane, cyclohexane, octane, and isoprene), aromatic hydrocarbon-based solvents (e.g., toluene, xylene, benzene, ethyl benzene, and naphthalene), aromatic heterocyclic compound-based solvents (e.g., furan, and thiophene), halide-based solvents (e.g., chloroform), ester-based solvents (e.g., ethyl acetate, isopropyl acetate, isobutyl acetate, and ethyl acrylate), nitrile-based solvents (e.g., acrylonitrile), and nitro-based solvents (e.g., nitromethane and nitroethane). These materials can be used singly or in combination of two or more of them.

Next, porous bodies such as hydrophilic silica, hydrophilic alumina, hydrophilic titanium oxide and the like are added to the thus obtained solution so that the solution is adsorbed by the porous bodies.

Next, the porous bodies adsorbing the solution is mixed with a polyether such as polyethyleneglycol, polypropyleneglycol and the like in a heating state. The mixing ratio of the porous bodies and the polyether is preferably in the rage of 1:0.5 to 1:10, and more preferably in the range of 1:1 to 1:5.

Further, the temperature at the time when the porous bodies and the polyether are mixed is preferably in the range of 5 to 80° C., and more preferably in the range of 20 to 80° C.

Next, the thus obtained mixture is dispersed into a petroleum carbon hydride sufficiently, and then it is cooled down so that the polyether is settled down on the surfaces of the porous bodies. Consequently, a coating of polyether is formed on the surface of each of the porous bodies.

Then, the petroleum carbon hydride is removed by filtering it to thereby obtain an encapsulated oxidation polymerization accelerator.

The amount of the oxidation polymerization accelerator contained in the magenta liquid developer with respect to 100 parts by weight of the insulation liquid is preferably in the range of 0.01 to 2 parts by weight, more preferably in the range of 0.05 to 1 parts by weight, and even more preferably in the range of 0.1 to 0.8 parts by weight. This makes it possible to progress the oxidation polymerization reaction reliably during the fixing process while preventing an oxidation polymerization reaction sufficiently during the storage or preservation of the liquid developer. Further, this also makes it possible to prevent an image quality of an obtained image from being lowered due to addition of the oxidation polymerization accelerator.

In this regard, it is to be noted that the oxidation polymerization accelerator may be contained in a black developer. In the case where the oxidation polymerization accelerator is also contained in the black developer, the amount of the oxidation polymerization accelerator contained in the black developer with respect to 100 parts by weight of the insulation liquid is preferably in the range of 0.01 to 2 parts by weight, more preferably in the range of 0.05 to 1 parts by weight, and even more preferably in the range of 0.1 to 0.8 parts by weight. In this case, it is also possible to fix the toner particles onto a recording medium firmly.

3. Toner Particles

Hereinafter, a detailed description will be made with regard to the toner particles.

<Constituent Materials of Toner Particles>

The toner particles (toner) which constitute the liquid developer according to the present invention contain at least a binder resin (resin material).

(1) Resin (Binder Resin)

Toner particles contained in a liquid developer are constituted from a material which contains a resin as a main component thereof.

In the present invention, there is no specific limitation on the kinds of a resin (binder resin) to be used. Examples of such a resin (binder resins) include styrene-based resins (homopolymers or copolymers containing styrene or a styrene substituent) such as polystyrene, poly-α-methylstyrene, chloropolystyrene, styrene-chlorostyrene copolymer, styrene-propylene copolymer, styrene-butadiene copolymer, styrene-vinyl chloride copolymer, styrene-vinyl acetate copolymer, styrene-maleic acid copolymer, styrene-acrylic ester copolymer, styrene-methacrylic ester copolymer, styrene-acrylic ester-methacrylic ester copolymer, styrene-α-methyl chloroacrylate copolymer, styrene-acrylonitrile-acrylic ester copolymer, and styrene-vinyl methyl ether copolymer, polyester-based resins, epoxy resins, urethane-modified epoxy resins, silicone-modified epoxy resins, vinyl chloride resins, rosin-modified maleic acid resins, phenyl resins, polyethylene-based resins, polypropylene, ionomer resins, polyurethane resins, silicone resins, ketone resins, ethylene-ethylacrylate copolymer, xylene reins, polyvinyl butyral resins, terpene reins, phenol resins, and aliphatic or alicyclic hydrocarbon resins. These binder resins can be used singly or in combination of two or more of them. Among these binder resins, polyester reins are preferably used since toner particles formed of the polyester resins can have especially high dispersibility in a liquid developer. This is supposed to be resulted from the fact that the polyester resin has high compatibility with plant oils.

The softening point of the resin (resin material) is not particularly limited to any specific value, but it is preferably in the range of 50 to 130° C., more preferably in the range of 50 to 120° C., and even more preferably in the range of 60 to 115° C. In this specification, the term “softening point” means a temperature at which softening is begun under the conditions that a temperature raising speed is 5° C./mim and a diameter of a die hole is 1.0 mm in a high-floored flow tester (manufactured by Shimadzu Corporation).

(2) Coloring Agent

The toner particles of the liquid developer may also contain a coloring agent. As for a coloring agent, pigments, dyes or the like can be used. Examples of such pigments and dyes include Carbon Black, Spirit Black, Lamp Black (C.I. No. 77266), Magnetite, Titanium Black, Chrome Yellow, Cadmium Yellow, Mineral Fast Yellow, Navel Yellow, Naphthol Yellow S, Hansa Yellow G, Permanent Yellow NCG, Benzidine Yellow, Quinoline Yellow, Tartrazine Lake, Chrome Orange, Molybdenum Orange, Permanent Orange GTR, Pyrazolone Orange, Benzidine Orange G, Cadmium Red, Permanent Red 4R, Watching Red Calcium Salt, Eosine Lake, Brilliant Carmine 3B, Manganese Violet, Fast Violet B, Methyl Violet Lake, Prussian Blue, Cobalt Blue, Alkali Blue Lake, Victoria Blue Lake, Fast Sky Blue, Indanthrene Blue BC, Ultramarine Blue, Aniline Blue, Phthalocyanine Blue, Chalco Oil Blue, Chrome Green, Chromium Oxide, Pigment Green B, Malachite Green Lake, Phthalocyanine Green, Final Yellow Green G, Rhodamine 6G, Quinacridone, Rose Bengal (C.I. No. 45432), C.I. Direct Red 1, C.I. Direct Red 4, C.I. Acid Red 1, C.I. Basic Red 1, C.I. Mordant Red 30, C.I. Pigment Red 48:1, C.I. Pigment Red 57:1, C.I. Pigment Red 122, C.I. Pigment Red 184, C.I. Direct Blue 1, C.I. Direct Blue 2, C.I. Acid Blue 9, C.I. Acid Blue 15, C.I. Basic Blue 3, C.I. Basic Blue 5, C.I. Mordant Blue 7, C.I. Pigment Blue 15:1, C.I. Pigment Blue 15:3, C.I. Pigment Blue 5:1, C.I. Direct Green 6, C.I. Basic Green 4, C.I. Basic Green 6, C.I. Pigment Yellow 17, C.I. Pigment Yellow 93, C.I. Pigment Yellow 97, C.I. Pigment Yellow 12, C.I. Pigment Yellow 180, C.I. Pigment Yellow 162, and Nigrosine Dye (C.I. No. 50415B); metal oxides such as metal complex dyes, silica, aluminum oxide, magnetite, maghemite, various kinds of ferrites, cupric oxide, nickel oxide, zinc oxide, zirconium oxide, titanium oxide, magnesium oxide, and the like; and magnetic materials including magnetic metals such as Fe, Co, and Ni; and the like. These pigments and dyes can be used singly or in combination of two or more of them.

(3) Other Components

The toner particles may contain additional components other than the above components. Examples of such other components include a wax, a charge control agent, a magnetic powder, and the like.

Examples of such a wax include hydrocarbon wax such as ozokerite, ceresin, paraffin wax, micro wax, microcrystalline wax, petrolatum, Fischer-Tropsch wax, or the like; ester wax such as carnauba wax, rice wax, methyl laurate, methyl myristate, methyl palmitate, methyl stearate, butyl stearate, candelilla wax, cotton wax, Japan wax, beeswax, lanolin, montan wax, fatty ester, or the like; olefin wax such as polyethylene wax, polypropylene wax, oxidized polyethylene wax, oxidized polypropylene wax, or the like; amide wax such as 12-hydroxystearic acid amide, stearic acid amide, phthalic anhydride imide, or the like; ketone wax such as laurone, stearone, or the like; ether wax; and the like. These waxes can be used singly or in combination of two or more.

Examples of the charge control agent include a metallic salt of benzoic acid, a metallic salt of salicylic acid, a metallic salt of alkylsalicylic acid, a metallic salt of catechol, a metal-containing bisazo dye, a nigrosine dye, tetraphenyl borate derivatives, a quaternary ammonium salt, an alkylpyridinium salt, chlorinated polyester, nitrohumic acid, and the like.

Further, examples of the magnetic powder include a powder made of a magnetic material containing a metal oxide such as magnetite, maghemite, various kinds of ferrites, cupric oxide, nickel oxide, zinc oxide, zirconium oxide, titanium oxide, magnesium oxide, or the like, and/or magnetic metal such as Fe, Co or Ni.

Further, the constituent material of the toner particles may further contain zinc stearate, zinc oxide, cerium oxide, silica, titanium oxide, iron oxide, fatty acid, or fatty acid metal salt, or the like in addition to the components described above.

(Shape of Toner Particles)

The average particle size (diameter) of the toner particles constituted from the above described materials is preferably in the range of 0.1 to 5 μm, more preferably in the range of 0.1 to 4 μm, even more preferably in the range of 0.5 to 3 μm. If the average particle size of the toner particles is within the above range, it is possible to make resolution of a toner image formed from the liquid developer (liquid toner) sufficiently high.

Further, it is also preferred that an average roundness R represented by the following formula (I) is preferably in the range of 0.94 to 0.99, and more preferably 0.96 to 0.99.

R=L₀/L₁ (I)

wherein L₁ (μm) represents the circumference of projected image of a toner particle that is a subject of measurement, and L₀ (μm) represents the circumference of a perfect circle (a geometrically perfect circle) having the same area as that of the projected image of the toner particle that is a subject of measurement.

When the average roundness R of the toner particles is within the above range, an appropriate amount of an insulation liquid can be contained in an unfixed image transferred onto a recording medium so that a fixing strength of the toner particles can be made higher.

Further, the amount of the toner particles contained in the liquid developer is preferably in the range of 10 to 60 wt %, and more preferably in the range of 10 to 30 wt %.

The liquid developer as described above may be formed by various methods. For example, in one method, electrolyte is added to a dispersion liquid (including an emulsified liquid) comprised of a dispersion medium and a toner material dispersed in the dispersion medium to obtain associated particles, the associated particles are then disassociated or disintegrated to obtain toner particles, and then the toner particles are dispersed in an insulation liquid to thereby obtain a liquid developer. In another method, a toner material is milled by a milling method to obtain toner particles, and then the toner particles are dispersed in an insulation liquid to thereby obtain a liquid developer. In still another method, a liquid developer is manufactured using a dispersion liquid obtained by dispersing a toner material into a dispersion medium (see, for example, JP-A 2006-178117).

The image forming method according to the present invention is a method of forming a color image using the liquid developers as described above. Specifically, the image forming method according to the present invention is a method which comprises forming a plurality of monochromatic color images using a plurality of liquid developers of different colors (developing step); transferring the plurality of monochromatic color images onto a recording medium to form an unfixed color image onto the recording medium (transfer step); and fixing the unfixed color image onto the recording medium (fixing step). This makes it possible to provide an image forming method which is harmless to environment and which can fix the toner particles firmly onto the recording medium while preventing an image quality of an obtained color image from being lowered.

### First Embodiment of Image Forming Apparatus (Liquid Developer Developing Apparatus)

Hereinbelow, a description will be made with regard to a first embodiment of an image forming apparatus according to the present invention.

The image forming apparatus is applied to the image forming method of the first embodiment, and the image forming apparatus forms a color image onto a recording medium using the liquid developers as described above.

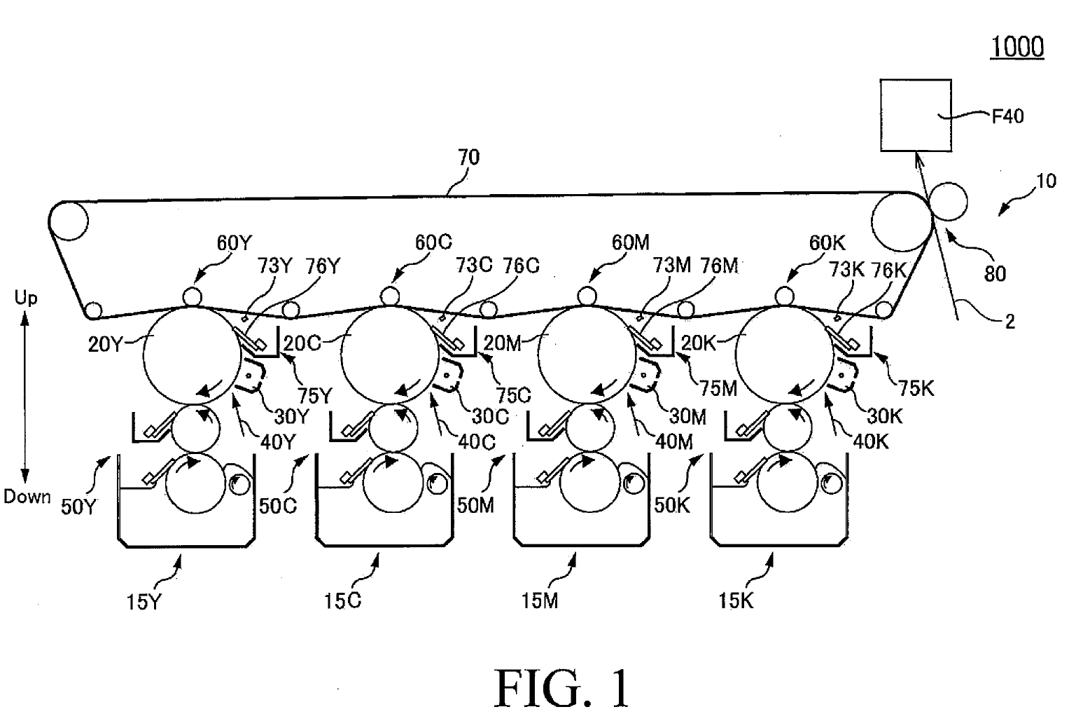

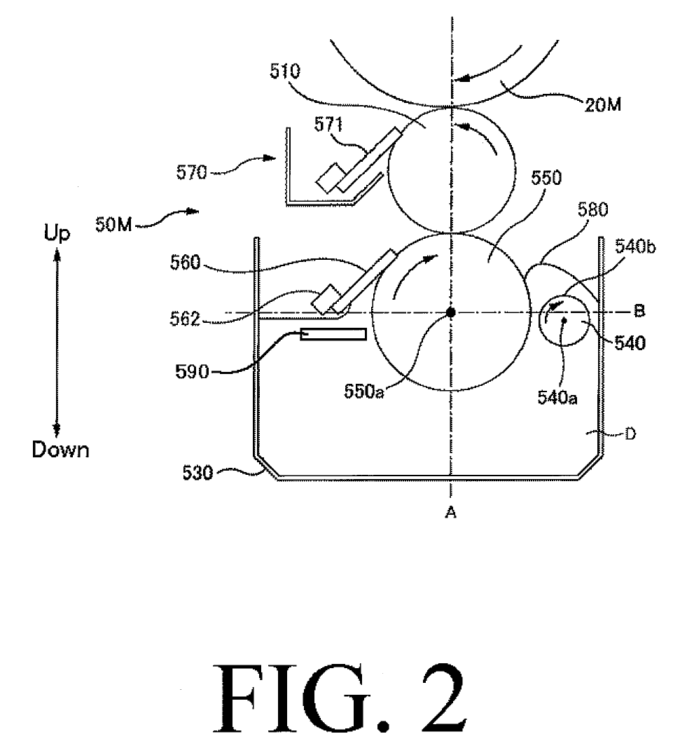

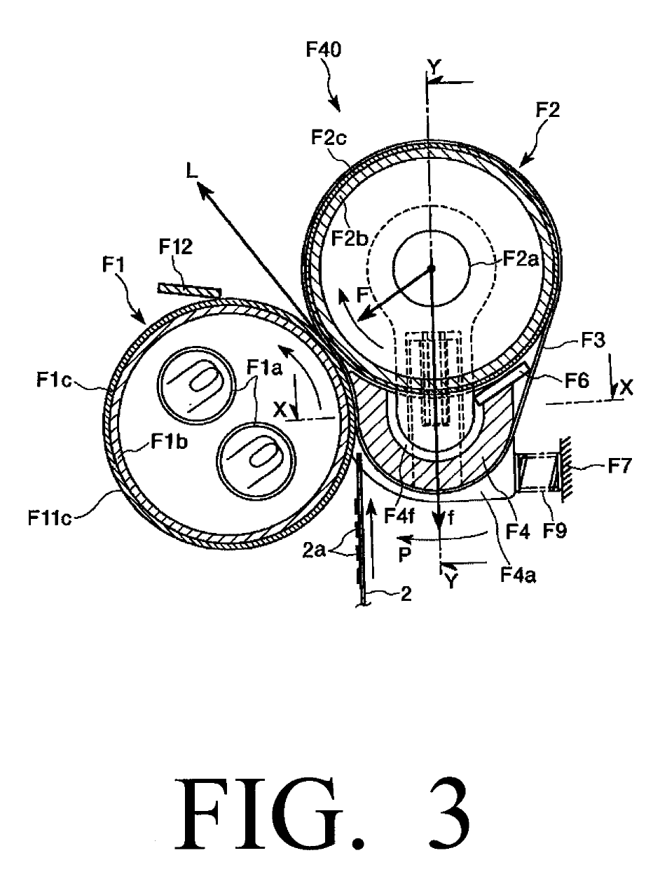

FIG. 1 is an illustration which shows one example of an image forming apparatus according to the present invention; FIG. 2 is a schematic view which shows one example of a developing unit provided in a liquid developer developing apparatus according to the present invention; and FIG. 3 is a cross-sectional view which shows one example of a fixing unit (device) provided in an image forming apparatus according to the present invention. In this regard, it is to be noted that in FIG. 1 the two-headed arrow indicates upper and lower directions.

As shown in FIG. 1, the image forming apparatus 1000 includes a liquid developer developing apparatus 10 and a fixing unit (fixing device) F40.

(Liquid Developer Developing Apparatus)

First, a description will be made with regard to the liquid developer developing apparatus 10 based on the accompanying drawings.

As shown in FIG. 1, the liquid developer developing apparatus 10 includes four developing sections comprised of 15Y, 15C, 15M and 15K, an intermediate transfer section 70, and a secondary transfer unit (secondary transfer section) 80.

The developing sections 15Y, 15C and 15M contain respectively a yellow (Y) liquid developer, a cyan (C) liquid developer, and a magenta (M) liquid developer, and have the functions of developing latent images with the liquid developers to form monochromatic color images corresponding to the respective colors. Further, the developing section 15K contains a black (B) liquid developer, and has the function of developing a latent image with the liquid developer to form a black monochromatic image.

The developing sections 15Y, 15C, 15M and 15K have the same structure. Therefore, in the following, the developing section 15M will be representatively described.

As shown in FIG. 1, the developing section 15M includes a photosensitive body 20M which carries a latent image and rotates in the direction of the arrow shown in the drawings. The image forming apparatus 10 further includes an electrifying unit 30M, an exposure unit 40M, a developing unit 50M, a primary transfer roller 60M, an electricity removal unit 73M and a cleaning unit 75M, and they are arranged in the named order along the rotational direction of the photosensitive body 20M.

The photosensitive body 20M includes a cylindrical conductive base member and a photosensitive layer (both not shown in the drawings) formed on the outer peripheral surface of the base member, and is rotatable about the axis thereof in the clockwise direction as shown by the arrow in FIG. 1.

The electrifying unit 30 is a device for uniformly electrifying the surface of the photosensitive body. The exposure unit 40 is a device that forms an electrostatic latent image on the uniformly electrified photosensitive body 20 by means of laser beam irradiation. The exposure unit 40 includes a semiconductor laser, a polygon mirror, or an F-θ lens, or the like, and irradiates a modulated laser beam onto the electrified photosensitive body 20M in accordance with image signals received from a host computer such as a personal computer, a word processor or the like not shown in the drawings.

The developing unit 50M is a device which develops the latent image to be visible with the magenta liquid developer. The details of the developing unit 50M will be described later.

The primary transfer unit (roller) 60M is a device for transferring a monochrome toner image formed on the photosensitive body 20M to the intermediate transfer section (belt) 70.

Monochromatic images corresponding to the respective colors formed by developing sections 15Y, 15C, 15M and 15K are sequentially transferred by the primary transfer units 60Y, 60C, 60M and 60B so that the monochromatic images corresponding to the respective colors are overlaid, thereby enabling a full color toner image (intermediate transferred image) to be formed on the intermediate transfer section 70 which will be described later.

The intermediate transfer section 70 includes an endless belt which is wound around a plurality of supporting rollers, and the endless belt is rotationally driven in contact with the respective photosensitive bodies 20Y, 20C, 20M and 20K.

The secondary transfer section 80 is a device for transferring an intermediate transferred image formed on the intermediate transfer belt 70 to a recording medium P such as paper, film, cloth, or the like.

A toner image (transferred image) 2a transferred onto a recording medium 2 by the secondary transfer section 80 is fed to a fixing unit (fixing device) F40 (which will be described later), where the unfixed toner image is fixed onto the recoding medium 2.

The electricity removal unit 73M is a device for removing residual electric charge on the photosensitive body 20M after the intermediate transferred image has been transferred onto the intermediate transfer section 70 by the primary transfer unit 60M.

The cleaning unit 75M includes a rubber-made cleaning blade 76M which makes contact with the surface of the photosensitive body 20M. The cleaning unit 75M is provided for scrapping off any toner that remains on the photosensitive body 20M by the cleaning blade 76M after the toner image has been transferred onto the intermediate transfer section (belt) 70 by the primary transfer unit (roller) 60.

As described above, the feature of this embodiment resides in the structure that the image forming apparatus includes the plurality of developing sections having the corresponding different color liquid developers, wherein among the liquid developers other than the black liquid developer only the magenta liquid developer contains an oxidation polymerization accelerator colored with read or its similar colors as described above. This makes it possible to fix toner particles onto a recording medium firmly while preventing an image quality of an obtained image from being lowered.

Further, in this embodiment, the developing section 15M containing the magenta liquid developer is arranged at a position from which a monochromatic color image formed using the magenta liquid developer is transferred onto the intermediate transfer section 70 at the last among the plurality of developing sections which form the monochromatic color images other than black (that is, yellow, cyan and magenta). In other words, among the plurality of developing sections which form the monochromatic color images, the developing section 15M located at the most downstream side in the rotational direction of the intermediate transfer section 70 contains a liquid developer containing the oxidation polymerization accelerator colored with read or its similar colors as described above.

According to the structure described above, among the monochromatic color images the monochromatic color image containing the oxidation polymerization accelerator has a layer position relatively close to the recoding medium in the intermediate toner image, so that the insulation liquid containing the oxidation polymerization accelerator is likely to be impregnated into the recording medium when the intermediate toner image is transferred onto the recording medium. As a result, since the unsaturated fatty acid component can be solidified during the fixing process in a state that it has been impregnated into the recording medium, it is possible to exhibit the anchoring effect described above, and this makes it is possible to fix the toner particles onto the recording medium more firmly.

Hereinbelow, a detailed description will be made with regard to the developing units 50Y, 50C, 50M and 50K. In this regard, it is to be noted that since the developing units 50Y, 50C, 50M and 50K have the same structure, in the following description the developing section 15M will be representatively described.

As shown in FIG. 2, the developing unit 50M includes a liquid developer storage section 530, a liquid developer supply roller 550, a liquid level raising roller 540, a regulating blade 560, a developing roller 510, and a developing roller cleaning unit 570.

The liquid developer storage section 530 is provided for storing a liquid developer D for developing a latent image formed on the photosensitive body 20M.

Further, as shown in FIG. 2, in the liquid developer storage section 530, there is provided a reducing member 590 for reducing oxidized unsaturated fatty acid components. The reducing member 590 is arranged in the vicinity of the liquid surface of the liquid developer in such a manner that the reducing member 590 is in contact with the liquid developer D in the liquid developer storage section 530.

The unsaturated fatty acid components in the liquid developer D stored in the liquid developer storage section 530 are components that are likely to be oxidized and polymerized. Therefore, if the liquid developer D is kept stored in the liquid developer storage section 530 for a long period of time, there is a case that an oxidation reaction progresses with elapse of time. As a result, the function as the insulation liquid is deteriorated, thus resulting in the case that an image quality of an obtained image is lowered. In particular, this tendency appears to be relatively strong in the case of the liquid developer containing an oxidation polymerization accelerator.

In view of this drawback, in the present embodiment, a reducing member 590 for reducing oxidized unsaturated fatty acid components is provided in the liquid developer storage section 530. With this result, it is possible to prevent deterioration of the function of the insulation liquid for long period of time, and this makes it possible to effectively prevent an image quality of an obtained image from being lowered.

The reducing member 590 is mainly constituted from zeolite. Zeolote has a structure of condensed aluminosilicate, which has a crystalline structure in which SiO₂ tetrahedral structure or AlO tetrahedral structure obtained by substituting Si of SiO₂ with Al are covalently-linked through oxygen atoms so as to form a three-dimensional network.

Zeolite has a cationic ion exchange property, and therefore it is believed that the oxidized unsaturated fatty acid components could be reduced due to this property.

The reducing member 590 is formed into a porous body. Such porous body can be obtained by sintering powder of zeolite.

In the case where the reducing member 590 is a porous body, since a contacting area with the liquid developer D becomes large, it is possible to reduce the unsaturated fatty acid components effectively. Further, since it is also possible to take up oxygen contained in the liquid developer D into its fine pores, oxidation of the unsaturated fatty acid components contained in the liquid developer D can be effectively prevented.

The porosity of the reducing member 590 is preferably in the range of 50 to 80 vol %, and more preferably in the range of 70 to 80 vol %. This makes it possible to reduce the unsaturated fatty acid components more effectively. Further, it is also possible to take up oxygen contained in the liquid developer D into fine pores more effectively.

Further, the reducing member 590 is replaceable. Therefore, it is possible to replace the used reducing member having reduced reduction property and adsorption ability with a new one.

In this regard, it is to be noted that in the structure shown in the drawing, the reducing member 590 is provided only in the developing unit 50M (developing section 15M) containing the magenta liquid developer. However, such a reducing member 590 may be provided in each of the developing units 50Y, 50C and 50K (developing sections 15Y, 15C, and 15K) in addition to the developing unit 50M. With this structure, since it is possible to prevent oxidation and deterioration of the unsaturated fatty acid components not only in the developing section from which a monochromatic color image is transferred onto the intermediate transfer section 70 at the last but also in other developing sections, it is possible to prevent an image quality of an obtained image from being lowered more effectively.

The liquid developer supply roller 550 has the function of supplying the liquid developer D to the developing roller 510. The liquid developer supply roller 550 is provided so that its surface is in press contact with an elastic body layer (described later) of the developing roller 510 in order to supply (transfer) the liquid developer D on the liquid developer supply roller 550 to the developing roller 510 appropriately. Further, the liquid developer supply roller 550 is rotatable about its central axis 550a, and the central axis 550a is positioned below the central axis of the developing roller 510. Further, the liquid developer supply roller 550 rotates in a direction (clockwise direction in FIG. 2) opposite to the rotational direction (anticlockwise direction in FIG. 2) of the developing roller 510.

Further, the liquid developer supply roller 550 is provided so as to be immersed into the liquid developer D contained in the liquid developer storage section 530 with a state that a part thereof is exposed over the liquid surface. Therefore, when the liquid developer supply roller 550 rotates in this state, the liquid developer supply roller 550 enters into the liquid developer D on the right side of a vertical plane A which passes through the central axis 550a of the liquid developer supply roller 550 as shown in FIG. 2 and the liquid developer supply roller 550 comes out of the liquid developer D on the left side of the vertical plane A as shown in FIG. 2.

The liquid level raising roller 540 has the function of raising the level of an entrance side liquid surface 580 which is on the side where the liquid developer supply roller 550 enters into the liquid developer D with its rotation with respect to the horizontal liquid surface B that is leveled with the central axis 550a of the liquid developer supply roller 550. In this embodiment, the liquid level raising roller 540 is formed of a SUS and has a diameter of 10 mm.

The liquid level raising roller 540 has a central axis 540a which is in parallel with the central axis 550a of the liquid developer supply roller 550, and it is arranged on the side where the liquid developer supply roller 550 enters into the liquid developer D (that is, on the right side of the vertical plane A in FIG. 2). Further, the central axis 540a of the liquid level raising roller 540 is positioned below the central axis 550a of the liquid developer supply roller 550 in the vertical direction, and the upper end 540b of the liquid level raising roller 540 is positioned above the central axis 550a of the liquid developer supply roller 550 in the vertical direction. Furthermore, the liquid level raising roller 540 is spaced apart from the liquid developer supply roller 550 with a clearance of 2 mm.

The liquid level raising roller 540 is rotatable about the central axis 540a, and it rotates in the same direction as the rotational direction of the liquid developer supply roller 550, that is, the clockwise direction in FIG. 2. Further, the rotation speed of the liquid level raising roller 540 is the same as the rotation speed of the liquid developer supply roller 550 in their liner velocity.

When the liquid level raising roller 540 having the above structure rotates, it raises the entrance side liquid surface 580 to a position higher than the horizontal liquid surface B. For example, when the liquid level raising roller 540 rotates in a state that the liquid surface is lower than the horizontal liquid surface B, the liquid developer D around the liquid level raising roller 540 moves upward according to the rotation of the liquid level raising roller 540 so that the entrance side liquid surface 580 becomes higher than the horizontal liquid surface B.

In this connection, it is to be note that in addition to the function described above, the liquid level raising roller 540 also has the function of supplying the liquid developer D onto the liquid developer supply roller 550 as well as the function of agitating the liquid developer D for keeping a practically usable state of the liquid developer D.

The regulating blade 560 is provided in contact with the surface of the liquid developer supply roller 550 for regulating an amount of the liquid developer D carried on the liquid developer supply roller 550. Specifically, the regulating blade 560 scrapes away an excess amount of the liquid developer D on the liquid developer supply roller 550 so that an amount of the liquid developer D to be supplied onto the developing roller 510 by the liquid developer supply roller 550 can be regulated. The regulating blade 560 is formed from an elastic body made of an urethane rubber, and supported by a regulating blade supporting member 562 made of a metal such as iron or the like. Further, the regulating blade 560 is arranged on the side where the liquid developer supply roller 550 comes out of the liquid developer D with its rotation (that is, on the left side of the vertical plane A in FIG. 2). In this regard, it is to be noted that the rubber hardness of the regulating blade 560, that is, a rubber hardness (62) of a portion of the regulating blade 560 which in press contact with the surface of the liquid developer supply roller 550 is about 62 according to JIS-A. The rubber hardness (62) of the regulating blade 560 is lower than the rubber hardness of an elastic layer of the developing roller 510 (described later) which is a rubber hardness (about 85) of a portion of the developing roller 510 which is in press contact with the surface of the liquid developer supply roller 550.

The developing roller 510 is provided for conveying the liquid developer D carried by the developing roller 510 to a developing position opposed to the photosensitive body 20M in order to develop a latent image carried on the photosensitive body 20M with the liquid developer D. The developing roller 510 includes an inner core member made of a metal such as iron or the like and an elastic layer having conductivity and provided onto an outer periphery of the inner core member. The diameter of the developing roller 510 is about 20 mm. The elastic layer has a two layered structure which includes an inner layer made of urethane rubber and an outer layer (surface layer) made of urethane rubber. The inner layer has a rubber hardness of 30 according to JIS-A and a thickness of about 5 mm, and the outer layer has a rubber hardness of about 85 according to JIS-A and a thickness of about 30 μm. The developing roller 510 is in press contact with both the liquid developer supply roller 550 and the photosensitive body 20M in a state that the outer layer of the developing roller 510 is elastically deformed.

The developing roller 510 is rotatable about its central axis, and the central axis is positioned below the central axis of the photosensitive body 20M. Further, the developing roller 510 rotates in a direction (clockwise direction in FIG. 2) opposite to the rotational direction (anti-clockwise direction in FIG. 2) of the photosensitive body 20M. It is to be noted that an electrical field is generated between the developing roller 510 and the photosensitive body 20M when a latent image formed on the photosensitive body 20M is developed.

The developing roller cleaning unit 570 is a device having a developing roller cleaning blade 571 which is in contact with the surface of the developing roller 510. The developing roller cleaning unit 570 is provided for scrapping away and then removing the liquid developer D remaining on the developing roller 510 with the developing roller cleaning blade 571 after development has been carried out at the developing position described above.

In the developing unit 50M having the above structure, when the liquid level raising roller 540 rotates about its central axis 540a, its rotation moves a part of the liquid developer D stored in the liquid developer storage section 530 toward the liquid developer supply roller 550 to supply the liquid developer D onto the liquid developer supply roller 550.

According to the rotation of the liquid developer supply roller 550, the liquid developer D reaches at the contacting position with the regulating blade 560, and when the liquid developer D passes through the contacting position, an excess amount of the liquid developer is scrapped away by the regulating blade 560 so that an amount of the liquid developer D to be supplied to the developing roller 510 is regulated.

According to further rotation of the liquid developer supply roller 550, the liquid developer carried by the liquid developer supply roller 550 reaches at the contacting portion with the developing roller 510. The liquid developer D conveyed at that contacting position is transferred from the liquid developer supply roll 550 to the developing roller 510 by virtue of the effect of the pressure produced by the pressure contact between the liquid developer supply roller 550 and the developing roller 510 to thereby form a thin film of the liquid developer D onto the developing roller 510.

The thin film of the liquid developer D formed on the developing roller 510 in this way reaches at the developing position opposed to the photosensitive body 20M (that is, the contacting position against the photosensitive body 20M) according to the rotation of the developing roller 510, and at that developing position the developing liquid D is used for development of a latent image formed on the photosensitive body 20M under the electrical field of a predetermined intensity. The liquid developer D on the developing roller 510 passing through the developing position then reaches the contacting position with the developing roller cleaning blade 571 according to further rotation of the developing roller 510. Then, the liquid developer adhering to the surface of the developing roller 510 is scrapped away by the developing roller cleaning blade 571 when it is passed through the contacting position with the developing roller cleaning blade 571. The scrapped liquid developer D is collected into a remaining liquid developer collecting section provided in the developing roller cleaning unit 570.

In this connection, it is to be noted that the liquid developer supply roller 550 begins to rotate in a state that the liquid level raising roller 540 is already rotating. Namely, in the liquid developer developing apparatus 10, the liquid developer supply roller 550 is rotated after the liquid level raising roller 540 is already rotated.

Hereinbelow, a description will be made with regard to a fixing unit (fixing device) 40 based on FIG. 3.

The fixing unit 40 is a device for fixing a toner image 2a formed by the liquid developer developing apparatus onto a recording medium 2.

As shown in FIG. 3, the fixing unit 40 is generally composed from a heat fixing roller F1, a pressure roller F2, a heat resistant belt F3, a belt tension member F4, a cleaning member F6, a frame F7, and a spring F9.

The heat fixing roller (hereinafter, simply referred to as “fixing roller”) F1 has a roller base F1b formed from a pipe member, an elastic body F1c which covers the outer periphery of the roller base F1b, and a pair of halogen lamps F1a provided inside the roller base Ft. Each of the halogen lamps F1a has a columnar shape and acts as a heat source. The heat fixing roller F1 having the above structure is rotatable in an anti-clockwise direction shown by the arrow in the drawing.

On the outer surface of the elastic body F1c of the heat fixing roller F1, there is formed a releasing layer F11c. The releasing layer F11c has the function of preventing toner particles from adhering to the surface of the heat fixing roller F1 during the fixing process.

Examples of a constituent material that can be used for forming the releasing layer F11c include fluoro rubbers such as polytetrafluoroethylene (PTFE), tetrafluoroethylene perfluoroalkylvinylehter copolymer (PFA), tetrafluoroethylene hexafluoropropylene copolymer (FEP), and the like, and silicone rubbers, and the like.

Further, as described above, inside the heat fixing roller F1, two halogen lamps F1a, F1a each having a columnar shape and acting as a heat source are provided. These halogen lamps F1a, F1a are provided with heating elements, respectively, which are arranged at different positions. With this arrangement, by selectively lighting up any one or both of the halogen lamps F1a, F1a, it is possible to easily carry out a temperature control under different conditions such as a case where a wide recording medium is used or a narrow recording medium is used, and/or a case where a fixing nip part at which the heat resistant belt F3 is wound around the heat fixing roller F1 is to be heated or a part at which the belt tension member F4 is in slidably contact with the heat fixing roller F1 is to be heated.

The pressure roller F2 is arranged so as to face the heat fixing roller F1 so that a pressing pressure is applied against the recording medium 2 on which an unfixed toner image is formed through a heat resistant belt F3.

Further, as described above, the pressure roller F2 has a roller base F2b formed from a pipe member and an elastic body F2c which covers the outer periphery of the roller base F2b. The pressure roller F2 is rotatable in a clockwise direction shown by the arrow in FIG. 3.

The elastic body F1c of the heat fixing roller F1 and the elastic body F2c of the pressure roller F2 are subjected to substantially uniform elastic deformation to form a so-called horizontal nip. Further, since there is no difference between a circumferential velocity of the heat fixing roller F1 and a conveying speed of a heat resistant belt F3 described below or a recording medium 2, it is possible to fix an image in an extremely stable manner.

The heat resistant belt F3 is a ring-shaped endless belt, and it is would around the outer circumferences of the pressure roller F2 and the belt tension member F4 so that it can be moved with being held between the heat fixing roller F1 and the pressure roller F2 in a pressed state.

The heat resistant belt F3 is formed from a seamless tube having a thickness of 0.03 mm or more. Further, the seamless tube has a two layered structure in which its surface (which is the surface thereof that makes contact with the recording medium 2) is formed of PFA, and the opposite surface thereof (that is, the surface thereof that makes contact with the pressure roller F2 and the belt tension member F4) is formed of polyimide. However, the structure of the heat resistant belt F3 is not limited to the structure described above, and it may be formed from other materials. Examples of tubes formed from other materials include a metallic tube such as a stainless tube or a nickel electrocasting tube, a heat-resistance resin tube such as a silicone tube, and the like.

The belt tension member F4 is disposed on the upstream side of the fixing nip part between the heat fixing roller F1 and the pressure roller F2 in the recording medium 2 conveying direction. Further, the belt tension member F4 is pivotally disposed about the rotation shaft F2a of the pressure roller F2 so as to be movable along the arrow P.

The belt tension member F4 is constructed so that the heat resistant belt F3 is extended with tension in the tangential direction of the heat fixing roller F1 in a state that the recording medium 2 does not pass through the fixing nip part. When the fixing pressure is large at an initial position where the recording medium 2 enters the fixing nip part, there is a case that the recording medium 2 can not enter the fixing nip part smoothly and thereby fixation is performed in a state that a tip part of the recording medium 2 is folded. However, in this embodiment, the belt tension member F4 is provided so that the heat resistant belt F3 is extended with tension in the tangential direction of the heat fixing roller F1 as described above, there is formed an introducing portion for smoothly introducing the recording medium 2, so that the recording medium 2 can be introduced into the fixing nip part in a stable manner.

The belt tension member F4 is a roughly semi-circular member for slidably guiding the heat resistant belt F3 (that is, the heat resistant belt F3 slidably moves on the belt tension member F4). The belt tension member F4 is fitted into the inside of the heat resistant belt F3 so as to impart tension f to the heat resistant belt F3 in cooperation with the pressure roller F2. The belt tension member F4 is arranged at a position where a nip part is formed by pressing a part of the heat resistant belt F3 toward the heat fixing roller F1 over the tangential line L on the pressing portion at which the heat fixing roller F1 is pressed against the pressure roller F2. The protruding wall F4a is formed on any one or both of the end surfaces of the belt tension member F4 which are located in the axial direction thereof. The protruding wall F4a is provided for restricting the heat resistant belt F3 from being off to the side by abutment thereto in a case that the heat resistant belt F3 is deviated in any one of the sides. Further, a spring F9 is provided between the frame and an end portion of the protruding wall F4a which is located at an opposite side from the heat fixing roller F1 so as to slightly press the protruding wall F4a of the belt tension member F4 against the heat fixing roller F1. In this way, the belt tension member F4 is positioned with respect to the heat fixing roller F1 in slidably contact with the heat fixing roller F1.

A position where the belt tension member F4 is slightly pressed against the heat fixing roller F1 is set as a nip starting position and a position where the pressure roller F2 is pressed against the heat fixing roller F1 is set as a nip ending position.

In the fixing unit F4, a recording medium 2 on which an unfixed toner image 2a is formed using an image forming apparatus 2a as described below enters into the fixing nip part from the nip starting position, then passes between the heat resistant belt F3 and the heat fixing roller F1, and then exits from the nip ending position, and in this way an unfixed toner image 2a formed on the recording medium 2 is fixed. Thereafter, the recording medium 2 on which the toner image is formed is fed out toward the tangential direction L of the pressing potion of the press roller F2 against the heat fixing roller F1.

The cleaning member F6 is disposed between the pressure roller F2 and the belt tension member F4.

The cleaning member F6 is provided for cleaning foreign substances or wear debris on the inner surface of the heat resistant belt F3 by slidably contacting with the inner surface of the heat resistant belt F3. By cleaning the foreign substances and wear debris in this way, it is possible to refresh the heat resistant belt F3 to eliminate the unstable factors on the frictional coefficients described above. Further, the belt tension member F4 is formed with a concave portion F4f, and this concave portion F4f is preferably used for collecting the foreign substances or wear debris eliminated from the heat resistant belt F3.

Further, the fixing unit F40 is provided with a removal blade (removal means) F12 for removing an insulation liquid adhering to or remaining on the surface of the heat fixing roller F1 after the toner image 2a has been fixed onto the recording medium 2. The insulation liquid removal blade F12 can not only remove the insulation liquid but also remove a toner or the like which has been transferred onto the heat fixing roller F1 at the same time upon fixation.

In order to stably drive the heat resistant belt F3 by the pressure roller F2 in a state that the heat resistant belt F3 is wound around the pressure roller F2 and the belt tension member F4, the frictional coefficient between the pressure roll F2 and the heat resistant belt F3 is set to be larger than the frictional coefficient between the belt tension member F4 and the heat resistant belt F3. However, there is a case that these frictional coefficients become unstable due to entering of foreign substances between the heat resistant belt F3 and the pressure roller F2 or between the heat resistant belt F3 and the belt tension member F4, or due to the abrasion of the contacting part between the heat resistant belt F3 and the pressure roller F2 or the belt tension member F4.

Accordingly, the winding angle of the heat resistant belt F3 with respect to the belt tension member F4 is set to be smaller than the winding angle of the heat resistant belt F3 with respect to the pressure roller F2, and the diameter of the belt tension member F4 is set to be smaller than the diameter of the pressure roller F2. With this structure, the distance that the heat resistant belt F3 moves on the belt tension member F4 becomes short so that unstable factors due to deterioration with the elapse of time and disturbance can be avoided or reduced. As a result, it is possible to drive the heat resistant belt F3 with the pressure roller F2 in a stable manner.

The fixing temperature for fixing an unfixed toner image is preferably in the range of 80 to 200° C., and more preferably 80 to 180° C. When the fixing temperature is in the above range, an oxidation polymerization reaction of the unsaturated fatty acid component can be progressed effectively. As a result, it is possible to increase fixing strength of the toner particles more effectively.

### Second Embodiment

### Second Embodiment of the Image Forming Method

Next, a description will be made with regard to the second embodiment of the image forming method. In this regard, it is to be noted that the following description focuses on the different portions from the first embodiment and a description on the common portions is omitted.

The second embodiment of the image forming method has the same steps as those of the first embodiment excepting that the plurality of liquid developers corresponding the different colors other than the black developer contain an oxidation polymerization accelerator colored with red or its similar colors, but the magenta liquid developer contains a largest amount of the oxidation polymerization accelerator.

In other words, the feature of the second embodiment is that the liquid developers include a black liquid developer, a yellow liquid developer and a cyan liquid developer in addition to the magenta liquid developer, wherein the magenta liquid developer, the yellow liquid developer and the cyan liquid developer contain an oxidation polymerization accelerator, but the magenta liquid developer contains a largest amount of the oxidation polymerization accelerator.

According to the image forming method as described above, it is possible to fix toner particles onto a recording medium firmly while preventing an image quality of an obtained image from being lowered. This is supposed to be resulted from the fact that magenta is a color which is similar to the color of the oxidation polymerization accelerator, that is, red or its similar colors, and therefore in the case of the magenta liquid developer, if it contains a relatively large amount of the oxidation polymerization accelerator, it is possible to make the affect received from the color of the oxidation polymerization accelerator small. Further, since the color liquid developers other than the magenta liquid developer (that is, the cyan liquid developer and the yellow liquid developer) contain an oxidation polymerization accelerator in an amount to such an extent that can suppress the affect to the image quality by the addition of the oxidation polymerization accelerator, it is possible to fix toner particles onto a recording medium firmly while preventing an image quality of an obtained image from being lowered.

As is the same with the first embodiment, the amount of the oxidation polymerization accelerator contained in the magenta liquid developer with respect to 100 parts by weight of the insulation liquid is preferably in the range of 0.01 to 2 parts by weight, more preferably in the range of 0.05 to 1 parts by weight, and even more preferably in the range of 0.1 to 0.8 parts by weight. This makes it possible to progress the oxidation polymerization reaction reliably during the fixing process while preventing an oxidation polymerization reaction sufficiently during the storage or preservation of the liquid developer. Further, this also makes it possible to prevent an image quality of an obtained image from being lowered due to the addition of the oxidation polymerization accelerator.

Further, when the amount of the oxidation polymerization accelerator contained in the magenta liquid developer with respect to 100 parts by weight of the insulation liquid is defined as X parts by weight and the amount of the oxidation polymerization accelerator contained in the yellow liquid developer with respect to 100 parts by weight of the insulation liquid is defined as Y parts by weight, it is preferred that the relation of Y/X≦0.1 is satisfied, and more preferably the relation of Y/X≦0.08 is satisfied. By satisfying such a relation, it is it possible to fix toner particles onto a recording medium more firmly while making the affect to an image quality of an obtained image due to the addition of the oxidation polymerization accelerator sufficiently small.

Furthermore, when the amount of the oxidation polymerization accelerator contained in the magenta liquid developer with respect to 100 parts by weight of the insulation liquid is defined as X parts by weight and the amount of the oxidation polymerization accelerator contained in the cyan liquid developer with respect to 100 parts by weight of the insulation liquid is defined as Z parts by weight, it is preferred that the relation of Z/X≦0.4 is satisfied, and more preferably the relation of Z/X≦0.2 is satisfied. By satisfying such a relation, it is it possible to fix toner particles onto a recording medium more firmly while making the affect to an image quality of an obtained image due to the addition of the oxidation polymerization accelerator sufficiently small.

Furthermore, in the case where the yellow liquid developer contains the oxidation polymerization accelerator, the amount of the oxidation polymerization accelerator contained in the yellow liquid developer with respect to 100 parts by weight of the insulation liquid is preferably 0.15 parts by weight or less, and more preferably 0.05 parts by weight or less. This makes it possible to make the affect to an image quality of an obtained image due to the addition of the oxidation polymerization accelerator sufficiently small.

Furthermore, in the case where the cyan liquid developer contains the oxidation polymerization accelerator, the amount of the oxidation polymerization accelerator contained in the cyan liquid developer with respect to 100 parts by weight of the insulation liquid is preferably 0.6 parts by weight or less, and more preferably 0.4 parts by weight or less. This makes it possible to make the affect to an image quality of an obtained image due to addition of the oxidation polymerization accelerator sufficiently small.

Moreover, the black liquid developer may contain the oxidation polymerization accelerator. In such a case, it is preferred that the amount of the oxidation polymerization accelerator contained in the black liquid developer with respect to 100 parts by weight of the insulation liquid is preferably in the range of 0.01 to 2 parts by weight or less, and more preferably 0.1 to 0.8 parts by weight or less. This makes it possible to fix toner particles onto a recording medium firmly.

Second Embodiment of Liquid Developer Developing Apparatus and Image Forming Apparatus

Next, a description will be made with regard to the second embodiment of the liquid developer developing apparatus and the image forming apparatus. In this regard, it is to be noted that the following description focuses on the different portions from the first embodiment and a description on the common portions is omitted.

The second embodiment of the liquid developer developing apparatus and the image forming apparatus has the same structures as those of the first embodiment excepting that the plurality of liquid developers corresponding the different colors other than the black developer contain an oxidation polymerization accelerator, but the magenta liquid developer contains a largest amount of the oxidation polymerization accelerator.

In other words, the feature of this second embodiment is that the liquid developers include a black liquid developer, a yellow liquid developer and a cyan liquid developer in addition to the magenta liquid developer, wherein the magenta liquid developer, the yellow liquid developer and the cyan liquid developer contain an oxidation polymerization accelerator, but the magenta liquid developer contains a largest amount of the oxidation polymerization accelerator.

This makes it possible to fix toner particles onto a recording medium firmly while making the affect to an image quality of an obtained image due to the addition of the oxidation polymerization accelerator sufficiently small.

In this embodiment, each of the liquid developers has the same structure as that of each of the liquid developers of the second embodiment of the image forming method.

In the foregoings, the present invention was described based on the preferred embodiments, but the present invention is not limited to these embodiments.

For example, the image forming method of the present invention may include one or more additional steps for arbitral purposes as needed.

Further, although the above first and second embodiments are directed to the case where four color liquid developers including magenta, yellow, cyan and black are used for formation of an image, the present invention is not limited to such a case. For examples, liquid developers of five colors or liquid developer of six or more colors may be employed. In this case, a liquid developer having a color similar to magenta, yellow or cyan but having a different color tone may be added.

Furthermore, the liquid developer developing apparatus and the image forming apparatus of the present invention are not limited to those shown in the drawings.

Moreover, the fixing unit used in the image forming apparatus of the present invention is also not limited to that used in the embodiments described above. Any elements or components of the fixing unit may be replaced with other arbitral elements or components that exhibit the same functions, and any structures or components may be added.

Moreover, in the above embodiments, heat is applied to fix the toner particles, but instead of heat, ultraviolet rays may be employed for fixing the toner particles.

Moreover, in the above embodiments, heat is applied from the side of the heat fixing roller, but instead thereof heat may be applied from the side of the pressure roller.

### EXAMPLES

(1) Production of Liquid Developer

<Magenta Liquid Developer A-1>

First, 80 parts by weight of a polyester resin of a self-dispersive type having a number of —SO₃— groups (sulfonic acid Na groups) at its side chains (glass transition point was 55° C., and softening temperature was 123° C.) and 20 parts by weight of a magenta-based pigment (“Pigment Red 122”, manufactured by Dainichi Seika Colors and Chemicals Mfg. Co., Ltd.) as a coloring agent were prepared.

These components were mixed using a 20 L type Henschel mixer to obtain a material for producing toner particles.

Next, the material (mixture) was kneaded using a biaxial kneader-extruder. The kneaded material that had been extruded from a discharge opening of the biaxial kneader-extruder was cooled using a cooling machine. Then, the cooled kneaded material was coarsely ground to be formed into powder having an average particle size of 1.0 mm or less. The grinding was carried out using a hammer mil.

Next, 250 parts by weight of toluene was added to 100 parts by weight of the coarse kneaded material, and then it was subjected to a treatment using an ultrasound homogenizer (output: 400 μA) for one hour to obtain a solution in which a self-dispersive type resin of the kneaded material was dissolved. In the solution, the pigment was finely dispersed homogeneously.

Further, a water-based liquid comprised of 700 parts by weight of an ion-exchange water was prepared. The water-based liquid was stirred with a homomixer (PRIMIX Corporation) with the number of stirring being adjusted.

The above-mentioned solution (that is, the toluene solution of the kneaded material) was dropped in the water-based liquid which was being stirred, to obtain a water-based emulsion in which a dispersoid comprised of particles having an average particle size of 1.2 μm was homogeneously dispersed.

Thereafter, the toluene in the water-based emulsion was removed under the conditions in which a temperature was 100° C. and an ambience pressure was 80 kPa, and then it was cooled to room temperature to thereby obtain a water-based suspension in which solid fine particles were dispersed. In the thus obtained water-based suspension, substantially no toluene remained. The concentration of the solid component (dispersoid) of the thus obtained water-based suspension was 30.5 wt %. Further, the average particle size of the particles of the dispersoid (solid fine particles) dispersed in the suspension was 0.8 μm. The measurement of the average particle size was carried out using a laser diffraction/scattering type particle size distribution measurement apparatus (“LA-920”, a product name of HORIBA Ltd.).

Then, the dispersion medium was removed from the thus obtained water-based suspension by drying it by splay drying to thereby obtain dry toner particles (toner particles).

Thereafter, 100 parts by weight of the toner particles, 160 parts by weight of a high iodine value flaxseed oil (produced by The Nisshin OilliO Group, Ltd.) as an insulation liquid, 4 parts by weight of a polyamine aliphatic condensation co-polymer (“Solspers 11200”, a product name of LUBRIZOL JAPAN LIMITED.) as a dispersant, and 0.56 parts by weight of aluminum stearate as a charge control agent were prepared.

These components were dispersed using an emulsion dispersing machine (manufactured by M Technique Co., Ltd.) at a rotation rate of 10,000 rpm with a care that a liquid temperature did not over the glass transition temperature of the resin, and then 1 parts by weight of encapsulated cobalt octylic acid as an oxidation polymerization accelerator was added to thereby obtain a liquid developer A-1.

In the thus obtained liquid developer A-1, the average particle size of the toner particles was 1.0 μm, and the standard deviation between the toner particles was 0.45 μm.

Encapsulation of the cobalt octylic acid was carried out as follows.

First, 10 g of cobalt octylic acid was dissolved in 15 ml of acetone, and then thus obtained solution was adsorbed to porous hydrophilic silica gel to thereby obtain core bodies.

Next, 10 g of the thus obtained core bodies and 20 g of polyethylene glycol (PEG) were mixed with being heated to thereby obtain a mixture.

Thereafter, the mixture was put into 400 ml of a solvent (AF6: Product of NIPPON MITSUBISHI OIL CORPORATION), and it was sufficiently dispersed in the solvent using a homomixer, and then it was gradually cooled down so that PEC was settled down. Then, the solvent was removed by a filtering member to thereby obtain a cobalt octylic acid with being encapsulated.

<Magenta Liquid Developer A-1′)

A liquid developer A-1′ was prepared in the same manner as in the liquid developer A-1 except that the oxidation polymerization accelerator was not added.

<Yellow Liquid Developer A-2>

A liquid developer A-2 was prepared in the same manner as in Example 1 except that a yellow based pigment (“Pigment Yellow 93”, manufactured by Dainichi Seika Colors and Chemicals Mfg. Co., Ltd.) was used as the coloring agent and that the oxidation polymerization accelerator was not added.

<Yellow Liquid Developer A-2′>

A liquid developer A-2′ was prepared in the same manner as in the liquid developer A-1 except that a yellow based pigment (“Pigment Yellow 93”, manufactured by Dainichi Seika Colors and Chemicals Mfg. Co., Ltd.) was used as the coloring agent.

<Cyan Liquid Developer A-3>

A liquid developer A-3 was prepared in the same manner as in the liquid developer A-1 except that a cyan based pigment (“Pigment Blue 15:3”, manufactured by Dainichi Seika Colors and Chemicals Mfg. Co., Ltd.) was used as the coloring agent and that the oxidation polymerization accelerator was not added.

<Cyan Liquid Developer A-3′>

A liquid developer A-3′ was prepared in the same manner as in the liquid developer A-1 except that a yellow based pigment (“Pigment Yellow 93”, manufactured by Dainichi Seika Colors and Chemicals Mfg. Co., Ltd.) was used as the coloring agent.

<Black Liquid Developer A-4>

A liquid developer A-4 was prepared in the same manner as in the liquid developer A-1 except that a carbon black was used as the coloring agent and that the oxidation polymerization accelerator was not added.

<Black Liquid Developer A-4′>

A liquid developer A-4′ was prepared in the same manner as in the liquid developer A-1 except that a carbon black was used as the coloring agent.

<Magenta Liquid Developer B-1>

First, 80 parts by weight of an epoxy resin (“EPIKOTE 1004”, a trademark of Japan Epoxy Resin Co., Ltd., of which softening point Tf was 128° C.) as a resin material and 20 parts by weight of a magenta-based pigment (“Pigment Red 122”, manufactured by Dainichi Seika Colors and Chemicals Mfg. Co., Ltd.) as a coloring agent were prepared.

These components were mixed using a 20 L type Henschel mixer to obtain a material for producing toner particles.

Next, the material (mixture) was kneaded using a biaxial kneader-extruder. The kneaded material that had been extruded from a discharge opening of the biaxial kneader-extruder was cooled using a cooling machine. Then, the cooled kneaded material was coarsely ground to be formed into powder having an average particle size of 1.0 mm or less. The grinding was carried out using a hammer mil.

Next, 100 parts by weight of the coarsely ground material, 100 parts by weight of oleic acid methyl as a first liquid, 10 parts by weight of a polyamine aliphatic condensation co-polymer (“Solspers 11200”, a product name of LUBRIZOL JAPAN LIMITED.) as a dispersant, and 1.4 parts by weight of magnesium stearate as a charge control agent were prepared.

These components were put into a ball mill and subjected to a wet grinding for 200 hours to thereby obtain a ground material dispersing liquid. Then, 100 parts by weight of the thus obtained ground material dispersing liquid and 400 parts by weight of a high oleic rape oil (produced by The Nisshin OilliO Group, Ltd.) as a second liquid were mixed, and then 1 parts by weight of encapsulated cobalt octylic acid as an oxidation polymerization accelerator was added to thereby obtain a liquid developer B-1.

In the thus obtained liquid developer B-1, the average particle size of the toner particles was 1.5 μm, and the standard deviation between the toner particles was 0.48 μm.

<Yellow Liquid Developer B-2>

A liquid developer B-2 was prepared in the same manner as the liquid developer B-1 mentioned above except that a yellow based pigment (“Pigment Yellow 93”, manufactured by Dainichi Seika Colors and Chemicals Mfg. Co., Ltd.) was used as the coloring agent and that the oxidation polymerization accelerator was not added.

<Cyan Liquid Developer B-3>

A liquid developer B-3 was prepared in the same manner as the liquid developer B-1 mentioned above except that a cyan based pigment (“Pigment Blue 15:3”, manufactured by Dainichi Seika Colors and Chemicals Mfg. Co., Ltd.) was used as the coloring agent and that the oxidation polymerization accelerator was not added.

<Black Liquid Developer B-4>

A liquid developer B-4 was prepared in the same manner as the liquid developer B-1 mentioned above except that a carbon black was used as the coloring agent and that the oxidation polymerization accelerator was not added.

<Magenta Liquid Developer C-1>

First, 80 parts by weight of an epoxy resin (“EPIKOTE 1004”, a trademark of Japan Epoxy Resin Co., Ltd., of which softening point Tf was 128° C.) as a resin material and 20 parts by weight of a magenta-based pigment (“Pigment Red 122”, manufactured by Dainichi Seika Colors and Chemicals Mfg. Co., Ltd.) as a coloring agent were prepared.

These components were mixed using a 20 L type Henschel mixer to obtain a material for producing toner particles.

Next, the material (mixture) was kneaded using a biaxial kneader-extruder. The kneaded material that had been extruded from a discharge opening of the biaxial kneader-extruder was cooled using a cooling machine. Then, the cooled kneaded material was coarsely ground to be formed into powder having an average particle size of 1.0 mm or less. The grinding was carried out using a hammer mil.

Next, 100 parts by weight of the coarsely ground material, 100 parts by weight of ISOPER H (a product name of Exson-Mobile Corporation), 10 parts by weight of a polyamine aliphatic condensation co-polymer (“Solspers 11200”, a product name of LUBRIZOL JAPAN LIMITED.) as a dispersant, and 1.4 parts by weight of magnesium stearate as a charge control agent were prepared.

These components were put into a ball mill and subjected to a wet grinding for 200 hours to thereby obtain a ground material dispersing liquid. Then, 100 parts by weight of the thus obtained ground material dispersing liquid and 400 parts by weight of ISOPER H were mixed to thereby obtain a liquid developer C-1.

In the thus obtained liquid developer C-1, the average particle size of the toner particles was 1.5 μm, and the standard deviation between the toner particles was 0.48 μm.

<Yellow Liquid Developer C-2>

A liquid developer C-2 was prepared in the same manner as the liquid developer C-1 mentioned above except that a yellow based pigment (“Pigment Yellow 93”, manufactured by Dainichi Seika Colors and Chemicals Mfg. Co., Ltd.) was used as the coloring agent.

<Cyan Liquid Developer C-3>

A liquid developer C-3 was prepared in the same manner as the liquid developer C-1 mentioned above except that a cyan based pigment (“Pigment Blue 15:3”, manufactured by Dainichi Seika Colors and Chemicals Mfg. Co., Ltd.) was used as the coloring agent.

<Black Liquid Developer C-4>

A liquid developer C-4 was prepared in the same manner as the liquid developer C-1 mentioned above except that a carbon black was used as the coloring agent.

(2) Image Formation

### Example 1

The liquid developers A-2, A-3, A-1 and A-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Example 2

The liquid developers A-2, A-1, A-3 and A-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Example 3

The liquid developers B-2, B-3, B-1 and B-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Comparative Example 1

The liquid developers A-2, A-3, A-1′ and A-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Comparative Example 2

The liquid developers A-2, A-3′, A-1′ and A-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Comparative Example 3

The liquid developers A-2′, A-3, A-1′ and A-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Comparative Example 4

The liquid developers A-2, A-3, A-1′ and A-4′ were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Comparative Example 5

The liquid developers C-2, C-3, C-4 and C-1 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

For each of the Examples 1 to 3 and the Comparative Examples 1 to 5, the colors of the liquid developers put into the respective developing sections and presence or absence of the oxidation polymerization accelerator were shown in the following TABLE 1.

TABLE 1

| | Developing | | Developing | | Developing | | Developing | |
|---|---|---|---|---|---|---|---|---|
| | Section 15Y | | Section 15C | | Section 15M | | Section 15K | |
| | | Oxidation | | Oxidation | | Oxidation | | Oxidation |
| | | polymerization | | polymerization | | polymerization | | polymerization |
| | Color | accelerator | Color | accelerator | Color | accelerator | Color | accelerator |
| Ex. 1 | Yellow | NO | Cyan | NO | Magenta | YES | Black | NO |
| Ex. 2 | Yellow | NO | Magenta | YES | Cyan | NO | Black | NO |
| Ex. 3 | Yellow | NO | Cyan | NO | Magenta | YES | Black | NO |
| Com. | Yellow | NO | Cyan | NO | Magenta | NO | Black | NO |
| Ex. 1 | | | | | | | | |
| Com. | Yellow | NO | Cyan | YES | Magenta | NO | Black | NO |
| Ex. 2 | | | | | | | | |
| Com. | Yellow | YES | Cyan | NO | Magenta | NO | Black | NO |
| Ex. 3 | | | | | | | | |
| Com. | Yellow | NO | Cyan | NO | Magenta | NO | Black | YES |
| Ex. 4 | | | | | | | | |
| Com. | Yellow | NO | Cyan | NO | Magenta | NO | Black | NO |
| Ex. 5 | | | | | | | | |

(3) Evaluation

(3-1) Fixing Strength

Each of the fixed toner images formed on the recording mediums obtained in the Examples 1 to 3 and the Comparative Examples 1 to 5 was rubbed out twice using a sand eraser (“LION 261-11”, Product of LION OFFICE PRODUCTS CORP.) with a pressure loading of 1.0 kgf. Then, the residual rate of the image density of each recording medium was measured by a calorimeter “X-Rite model 404” (X-Rite Incorporated), and the measurement, results were evaluated according to the following five criteria.

AA: Residual rate of the image density was 95% or higher

A: Residual rate of the image density was 90% or higher but lower than 95%

B: Residual rate of the image density was 80% or higher but lower than 90%

C: Residual rate of the image density was 70% or higher but lower than 80%

D: Residual rate of the image density was lower than 70%

(3-2) Evaluation of Image Quality (Colors)

In each of the fixed toner images formed on the recording mediums obtained in the Examples 1 to 3 and the Comparative Examples 1 to 5, a color mixture patch of magenta, yellow and cyan and a patch of black were subjected to color measurement using an X-Rite 968, color reproductivity with respect to the fixing patch obtained in the case where no oxidation polymerization accelerator was added was evaluated according to the following three criteria.

A: There was no difference from the original image (ΔE≦3)

B: Slightly different from the color of the original image (3<ΔE<5)

C: Considerably different from the color of the original image (ΔE≧5)

These results are shown in the following TABLE 2.

TABLE 2

Fixing Strength

| | Residual ratio | | |
|---|---|---|---|
| | of image | | Evaluation |
| | density | | of image |
| | [%] | Evaluation | quality |
| Ex. 1 | 98 | AA | A |
| Ex. 2 | 94 | A | A |
| Ex. 3 | 89 | B | A |
| Com. Ex. 1 | 72 | C | A |
| Com. Ex. 2 | 93 | A | C |
| Com. Ex. 3 | 92 | A | C |
| Com. Ex. 4 | 79 | C | A |
| Com. Ex. 5 | 60 | D | A |

As is apparent from TABLE 2, each of the Examples 1 to 3 was excellent in the fixing strength and the image quality. In contrast, in each of the Comparative Examples 1 to 5, satisfactory results could not be obtained.

(4) Production of Liquid Developer

<Magenta Liquid Developer D-1>

(Preparation of Insulation Liquid)

A liquid containing unsaturated fatty acid gryceride and a liquid containing fatty acid monoester both used for an insulation liquid were prepared as follows.

Preparation of Liquid Containing Unsaturated Fatty Acid Glyceride

A roughly refined soy oil was refined in the following manner to thereby obtain a refined soy oil.

Specifically, at first, a roughly refined soy oil was prepared by a cold crystallization method using methanol, diethyl ether, petroleum ether, or acetone, or the like as a solvent.

Next, 300 parts by volume of the roughly refined soy oil (first roughly refined oil) was put into a flask, and then 100 part by volume of boiled water was poured into the flask and the flask was plugged.

Next, the flask was shaken to mix the roughly refined soy oil (first roughly refined oil) and the boiled water.

Next, the flask was being left until the mixture in the flask was separated into three layers.

After the separation was confirmed, the flask was placed in a freezer and was being left as it is for 24 hours.

Then, a component which had not been frozen was transferred to another flask.

The unfrozen component was subjected to the above processes again to extract a component that had not been frozen to thereby obtain a roughly refined fatty oil (second roughly refined oil).

Next, 100 parts by volume of the thus obtained roughly refined fatty oil and 35 parts by volume of an activated earth mainly constituted of a hydrous aluminum silica were put into a flask, and then they were mixed and stirred.

Next, the thus obtained mixture was preserved under pressure of 0.18 Mpa for 48 hours, so that the activated earth was completely settled down.

Then, the precipitate was removed to thereby obtain a refined soy oil (hereinafter, simply referred to as “soy oil”) In the thus obtained soy oil, unsaturated fatty acid glyceride comprised of a linolic acid as its main component was contained, and the unsaturated fatty acid glyceride in the soy oil was 98 wt %. Further, the linolic acid component contained in all the fatty acid components was 53 mol %.

Preparation of Liquid Containing Fatty Acid Monoester

Next, an ester-exchange reaction was carried out for a part of the thus obtained soy oil and methanol, and then glycerin produced by this reaction was removed to thereby obtain a liquid mainly constituted from fatty acid monoester. Thereafter, by further refining the liquid, soy oil fatty acid methyl ester containing fatty acid monoester of 99.9 wt % or higher was obtained. The thus obtained fatty acid monoester was mainly constituted from unsaturated fatty acid monoester such as methyl oleate, methyl linoleate, α-methyl linoleate, and the like, and saturated fatty acid monoester such as methyl palmitate, methyl stearate, and the like.

(Preparation of Toner Particles)

Preparation of Master Solution of Coloring Agent

First, a mixture of a polyester resin (melt viscosity was 125° C., Tg was 60.5° C., and acid value was 7.7) and a magenta based pigment (“Pigment Red 122”, manufactured by Dainichi Seika Colors and Chemicals Mfg. Co., Ltd.) as a coloring agent was prepared (mixing ratio was 50:50 in mass ratio). Then, they were mixed using a 20 L type Henschel mixer to obtain a material for producing toner particles.

Next, the material (mixture) was kneaded using a biaxial kneader-extruder. The kneaded material that had been extruded from a discharge opening of the biaxial kneader-extruder was cooled using a cooling machine. Then, the cooled kneaded material was coarsely ground to be formed into powder having an average particle size of 1.0 mm or less. The grinding was carried out using a hammer mil.

Then, methyl ethyl ketone was added to the thus obtained powder of the kneaded material so that the amount of the solid component became 30 wt %, and it was subjected to wet dispersion using an Eiger motor mill (M-1000, a product code of Eiger Engineering Ltd.) to thereby prepare a master solution of a coloring agent.

Preparation of Resin Solution

200 parts by weight of methyl ethyl ketone and 73 parts by weight of the polyester resin were added to 33 parts by weith of the coloring agent master solution, and they were mixed by an Eiger motor mill (M-1000, a product code of Eiger Engineering Ltd.) to thereby prepare a resin solution. It is to be noted that in this solution, the pigment was finely dispersed homogeneously.

Preparation of Water-based Emulsion

500 parts by weight of the resin solution and 45.5 parts by weight of methyl ethyl ketone were put into a separable flask having a cylindrical shape with a maxblend stirring blade and having a size of 2 litter so that the amount of the solid component of the resin solution became 55%.

Then, 41.7 parts by weight of 1N NH₄OH (mole equivalent ratio with respect to the total amount of carboxyl groups possessed by the polyester resin was 1:1) was added to the resin solution in the flask, and then the mixture was stirred sufficiently by a three-one motor (produced by Shinto Scientific Co., Ltd.) at a rotational speed of the stirring blade of 210 rpm (peripheral velocity of the stirring blade was 0.71 m/s), and then 133 parts by weight of deionized water was added while maintaining the stirring. Namely, the temperature of the solution in the flask was adjusted to 25° C., and 133 parts by weight of deionized water was dropped into the resin solution while maintaining the stirring to cause phase-inversion emulsification to thereby obtain a water-based emulsion in which the dispersoid containing the resin material was dispersed.

Production of Associated Particles

Next, 285 parts by weight of deionized water was added to the water-based emulsion so that the total amount of 1N NH₄OH and water became 593 parts by weight while maintaining the stirring in the flask. Then, 2.6 parts by weight of an anionic emulsifying agent (“EMAL”, a product name of Kao Chemical Company) with being diluted with 30 parts by weight of deionized water was added to the water-based emulsion.

Thereafter, with maintaining the temperature of the water-based emulsion at 25° C., 300 parts by weight of 3.5% ammonium sulfate aqueous solution was dropped under the rotational number of the stirring of 150 rpm (peripheral velocity of the stirring blade was 0.54 m/s) so that the particle size of the associated body of the dispersoid became 3.5 μm. After the completion of the drop of the ammonium sulfate aqueous solution, the stirring was continued until the particle size of the associated body of the dispersoid grown to be 5.0 μm, and then the association process was completed.

The thus obtained associated body dispersing liquid was dried by removing the organic solvent under reduced pressure to thereby obtain associated particles.

(Preparation of Liquid Developer)

40 parts by weight of the associated particles obtained by the method mentioned above, 80 parts by weight of soy oil fatty acid methyl ester, and 1 parts by weight of a polyamine aliphatic condensation co-polymer (“Solspers 13940”, a product name of LUBRIZOL JAPAN LIMITED.) were put into a ceramic pot (inner volume of 600 ml), and further zirconia balls (a diameter of each ball was 1 mm) were also put into the ceramic pot so that a volume filling rate became 25%. Thereafter, disassociation was being carried out for 120 hours using a bench pot mill at a rotation speed of 210 rpm (1/min). Then, the dispersion liquid in the pot was taken out separately from the zirconia balls to thereby obtain a toner particle dispersion liquid.

Next, 120 parts by weight of a refined soy oil, 0.5 parts by weight of zinc stearate (NOF Corporation) as a charge control agent, and 0.5 parts by weight of encapsulated cobalt naphthenate as an oxidation polymerization accelerator t (this amount means an amount of cobalt naphthenate itself) were added to the thus obtained toner particle dispersion liquid, and then disassociation was being carried out for 24 hours to thereby obtain a liquid developer D-1.

In the thus obtained liquid developer D-1, the average particle size of the toner particles was 1.9 μm, and the standard deviation between the toner particles was 0.54 μm.

In this connection, it is to be noted that the average particle size (average particle size based on the volume of each particle) and the particle size distribution was measured using Mastersizer 2000 particle analyzer (manufactured by Malvern Instruments Ltd.).

Further, the encapsulation of the cobalt naphthenate was carried out as follows.

First, 10 g of cobalt naphthenate was dissolved in 15 ml of acetone, and then the thus obtained solution was adsorbed by porous hydrophilic silica gel to thereby obtain core bodies.

Next, 10 g of the thus obtained core bodies and 20 g of polyethylene glycol (PEG) were mixed with being heated to thereby obtain a mixture.

Thereafter, the mixture was put into 400 ml of a solvent (AF6: Product of NIPPON MITSUBISHI OIL CORPORATION), and it was sufficiently dispersed in the solvent using a homomixer, and then it was gradually cooled down so that PEC was settled down. Then, the solvent was removed by a filtering member to thereby obtain a cobalt naphthenate with being encapsulated.

<Yellow Liquid Developer D-2>

A liquid developer D-2 was prepared in the same manner as in the liquid developer D-1 except that a yellow based pigment (“Pigment Yellow 93”, manufactured by Dainichi Seika Colors and Chemicals Mfg. Co., Ltd.) was used as the coloring agent and that the amount of the oxidation polymerization accelerator was changed to 0.01 parts by weight with respect to 100 parts by weight of the insulation liquid.

<Cyan Liquid Developer D-3>

A liquid developer D-3 was prepared in the same manner as in the liquid developer D-1 except that a cyan based pigment (“Pigment Blue 15:3”, manufactured by Dainichi Seika Colors and Chemicals Mfg. Co., Ltd.) was used as the coloring agent and that the amount of the oxidation polymerization accelerator was changed to 0.1 parts by weight with respect to 100 parts by weight of the insulation liquid.

<Black Liquid Developer D-4>

A liquid developer D-4 was prepared in the same manner as in the liquid developer D-1 except that a carbon black was used as the coloring agent.

<Magenta Liquid Developer E-1>

A liquid developer E-1 was prepared in the same manner as in the liquid developer D-1 except that the oxidation polymerization accelerator was not added.

<Yellow Liquid Developer E-2>

A liquid developer E-2 was prepared in the same manner as in the liquid developer D-1 except that a yellow based pigment (“Pigment Yellow 93”, manufactured by Dainichi Seika Colors and Chemicals Mfg. Co., Ltd.) was used as the coloring agent and that the oxidation polymerization accelerator was not added.

<Cyan Liquid Developer E-3>

A liquid developer E-3 was prepared in the same manner as in the liquid developer D-1 except that a cyan based pigment (“Pigment Blue 15:3”, manufactured by Dainichi Seika Colors and Chemicals Mfg. Co., Ltd.) was used as the coloring agent and that the oxidation polymerization accelerator was not added.

<Black Liquid Developer E-4>

A liquid developer E-4 was prepared in the same manner as in the liquid developer D-1 except that a carbon black was used as the coloring agent and that the oxidation polymerization accelerator was not added.

<Magenta Liquid Developer F-1>

A liquid developer F-1 was prepared in the same manner as in the liquid developer D-1 except that the amount of the oxidation polymerization accelerator was changed to 2 parts by weight with respect to 100 parts by weight of the insulation liquid.

<Yellow Liquid Developer F-2>

A liquid developer F-2 was prepared in the same manner as in the liquid developer D-1 except that a yellow based pigment (“Pigment Yellow 93”, manufactured by Dainichi Seika Colors and Chemicals Mfg. Co., Ltd.) was used as the coloring agent and that the amount of the oxidation polymerization accelerator was changed to 0.2 parts by weight with respect to 100 parts by weight of the insulation liquid.

<Cyan Liquid Developer F-3>

A liquid developer F-3 was prepared in the same manner as in the liquid developer D-1 except that a cyan based pigment (“Pigment Blue 15:3”, manufactured by Dainichi Seika Colors and Chemicals Mfg. Co., Ltd.) was used as the coloring agent and that the amount of the oxidation polymerization accelerator was changed to 0.6 parts by weight with respect to 100 parts by weight of the insulation liquid.

<Black Liquid Developer F-4>

A liquid developer F-4 was prepared in the same manner as in the liquid developer D-1 except that a carbon black was used as the coloring agent and that the oxidation polymerization accelerator was not added and that the amount of the oxidation polymerization accelerator was changed to 2 parts by weight with respect to 100 parts by weight of the insulation liquid.

<Magenta Liquid Developer G-1>

A liquid developer G-1 was prepared in the same manner as in the liquid developer D-1 except that the amount of the oxidation polymerization accelerator was changed to 0.5 parts by weight with respect to 100 parts by weight of the insulation liquid.

<Yellow Liquid Developer G-2>

A liquid developer G-2 was prepared in the same manner as in the liquid developer D-1 except that a yellow based pigment (“Pigment Yellow 93”, manufactured by Dainichi Seika Colors and Chemicals Mfg. Co., Ltd.) was used as the coloring agent and that the amount of the oxidation polymerization accelerator was changed to 0.04 parts by weight with respect to 100 parts by weight of the insulation liquid.

<Cyan Liquid Developer G-3>

A liquid developer G-3 was prepared in the same manner as in the liquid developer D-1 except that a cyan based pigment (“Pigment Blue 15:3”, manufactured by Dainichi Seika Colors and Chemicals Mfg. Co., Ltd.) was used as the coloring agent and that the amount of the oxidation polymerization accelerator was changed to 0.1 parts by weight with respect to 100 parts by weight of the insulation liquid.

<Black Liquid Developer G-4>

A liquid developer G-4 was prepared in the same manner as in the liquid developer D-1 except that a carbon black was used as the coloring agent and that the oxidation polymerization accelerator was not added and that the amount of the oxidation polymerization accelerator was changed to 0.5 parts by weight with respect to 100 parts by weight of the insulation liquid.

<Magenta Liquid Developer H-1>

A liquid developer H-1 was prepared in the same manner as in the liquid developer D-1 except that the amount of the oxidation polymerization accelerator was changed to 0.1 parts by weight with respect to 100 parts by weight of the insulation liquid.

<Yellow Liquid Developer H-2>

A liquid developer H-2 was prepared in the same manner as in the liquid developer D-1 except that a yellow based pigment (“Pigment Yellow 93”, manufactured by Dainichi Seika Colors and Chemicals Mfg. Co., Ltd.) was used as the coloring agent and that the amount of the oxidation polymerization accelerator was changed to 0.005 parts by weight with respect to 100 parts by weight of the insulation liquid.

<Cyan Liquid Developer H-3>

A liquid developer H-3 was prepared in the same manner as in the liquid developer D-1 except that a cyan based pigment (“Pigment Blue 15:3”, manufactured by Dainichi Seika Colors and Chemicals Mfg. Co., Ltd.) was used as the coloring agent and that the amount of the oxidation polymerization accelerator was changed to 0.005 parts by weight with respect to 100 parts by weight of the insulation liquid.

<Black Liquid Developer H-4>

A liquid developer H-4 was prepared in the same manner as in the liquid developer D-1 except that a carbon black was used as the coloring agent and that the oxidation polymerization accelerator was not added and that the amount of the oxidation polymerization accelerator was changed to 0.1 parts by weight with respect to 100 parts by weight of the insulation liquid.

<Magenta Liquid Developer I-1>

A liquid developer I-1 was prepared in the same manner as in the liquid developer D-1 except that encapsulated manganese naphthenate was used as the oxidation polymerization accelerator.

<Yellow Liquid Developer I-2>

A liquid developer I-2 was prepared in the same manner as in the liquid developer D-2 except that encapsulated manganese naphthenate was used as the oxidation polymerization accelerator.

<Cyan Liquid Developer I-3>

A liquid developer I-3 was prepared in the same manner as in the liquid developer D-3 except that encapsulated manganese naphthenate was used as the oxidation polymerization accelerator.

<Black Liquid Developer I-4>

A liquid developer I-4 was prepared in the same manner as in the liquid developer D-4 except that encapsulated manganese naphthenate was used as the oxidation polymerization accelerator.

<Magenta Liquid Developer J-1>

A liquid developer J-1 was prepared in the same manner as in the liquid developer D-1 except that encapsulated manganese octylic acid was used as the oxidation polymerization accelerator.

<Yellow Liquid Developer J-2>

A liquid developer J-2 was prepared in the same manner as in the liquid developer D-2 except that encapsulated manganese octylic acid was used as the oxidation polymerization accelerator.

<Cyan Liquid Developer J-3>

A liquid developer J-3 was prepared in the same manner as in the liquid developer D-3 except that encapsulated manganese octylic acid was used as the oxidation polymerization accelerator.

<Black Liquid Developer J-4>

A liquid developer J-4 was prepared in the same manner as in the liquid developer D-4 except that encapsulated manganese octylic acid was used as the oxidation polymerization accelerator.

<Yellow Liquid Developer K-2>

A liquid developer K-2 was prepared in the same manner as in the liquid developer D-1 except that a yellow based pigment (“Pigment Yellow 93”, manufactured by Dainichi Seika Colors and Chemicals Mfg. Co., Ltd.) was used as the coloring agent and that the amount of the oxidation polymerization accelerator was changed to 2 parts by weight with respect to 100 parts by weight of the insulation liquid.

<Cyan Liquid Developer K-3>

A liquid developer K-3 was prepared in the same manner as in the liquid developer D-1 except that a cyan based pigment (“Pigment Blue 15:3”, manufactured by Dainichi Seika Colors and Chemicals Mfg. Co., Ltd.) was used as the coloring agent and that the amount of the oxidation polymerization accelerator was changed to 2 parts by weight with respect to 100 parts by weight of the insulation liquid.

(5) Image Formation

### Example 4

The liquid developers E-2, E-3, D-1 and E-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Example 5

The liquid developers E-2, E-3, F-1 and E-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Example 6

The liquid developers E-2, E-3, G-1 and E-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Example 7

The liquid developers E-2, E-3, H-1 and H-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Example 8

The liquid developers E-2, E-3, I-1 and E-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Example 9

The liquid developers E-2, E-3, J-1 and E-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Example 10

The liquid developers E-2, D-1, E-3 and E-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Example 11

The liquid developers D-2, D-3, D-1 and D-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Example 12

The liquid developers F-2, F-3, F-1 and F-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Example 13

The liquid developers G-2, G-3, G-1 and G-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Example 14

The liquid developers H-2, H-3, H-1 and H-4 were put into the developing sections 15Y, 15C, 15N and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Example 15

The liquid developers H-2, H-3, H-1 and E-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Example 16

The liquid developers I-2, I-3, I-1 and I-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Example 17

The liquid developers J-2, J-3, J-1 and J-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Example 18

The liquid developers D-2, D-1, D-3 and D-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Comparative Example 6

The liquid developers E-2, E-3, E-1 and E-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Comparative Example 7

The liquid developers E-2, E-3, E-1 and D-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Comparative Example 8

The liquid developers K-2, K-3, E-1 and E-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

### Comparative Example 9

The liquid developers K-2, K-3, E-1 and F-4 were put into the developing sections 15Y, 15C, 15M and 15K of the liquid developer 10 as shown in FIG. 1, respectively, and then an unfixed predetermined toner image was formed onto a recording medium (“J Paper”, produced by Fuji Xerox Office Supply Co., Ltd.) at room temperature, and then the toner image was fixed using the fixing unit as shown in FIG. 3.

For each of the Examples 4-18 and the Comparative Examples 6-9, the colors of the liquid developers put into the respective developing sections and the amount of the oxidation polymerization accelerator with respect to 100 parts by weight of the insulation liquid were shown in the following TABLE 3. Further, when the amount of the oxidation polymerization accelerator contained in the magenta liquid developer with respect to 100 parts by weight of the insulation liquid is defined as X parts by weight, the amount of the oxidation polymerization accelerator contained in the yellow liquid developer with respect to 100 parts by weight of the insulation liquid, and the amount of the oxidation polymerization accelerator contained in the cyan liquid developer with respect to 100 parts by weight of the insulation liquid is defined as Z parts by weight, the values X/Y and Z/X were also shown in the TABLE 3.

TABLE 3

| | Developing | | Developing | | Developing | | Developing | | | |
|---|---|---|---|---|---|---|---|---|---|---|
| | Section 15Y | | Section 15C | | Section 15M | | Section 15K | | | |
| | | Amount of | | Amount of | | Amount of | | Amount of | | |
| | | oxidation | | oxidation | | oxidation | | oxidation | | |
| | | polymerization | | polymerization | | polymerization | | polymerization | | |
| | | accelerator with | | accelerator with | | accelerator with | | accelerator with | | |
| | | respect to 100 | | respect to 100 | | respect to 100 | | respect to 100 | | |
| | | parts by weight of | | parts by weight of | | parts by weight of | | parts by weight of | | |
| | | insulation liquid | | insulation liquid | | insulation liquid | | insulation liquid | | |
| | Color | [parts by weight] | Color | [parts by weight] | Color | [parts by weight] | Color | [parts by weight] | Y/X | Y/X |
| Ex. 4 | Yellow | 0 | Cyan | 0 | Magenta | 0.25 | Black | 0 | — | — |
| Ex. 5 | Yellow | 0 | Cyan | 0 | Magenta | 2 | Black | 0 | — | — |
| Ex. 6 | Yellow | 0 | Cyan | 0 | Magenta | 0.5 | Black | 0 | — | — |
| Ex. 7 | Yellow | 0 | Cyan | 0 | Magenta | 0.1 | Black | 0.1 | — | — |
| Ex. 8 | Yellow | 0 | Cyan | 0 | Magenta | 0.25 | Black | 0 | — | — |
| Ex. 9 | Yellow | 0 | Cyan | 0 | Magenta | 0.25 | Black | 0 | — | — |
| Ex. 10 | Yellow | 0 | Ma- | 0.25 | Cyan | 0 | Black | 0 | — | — |
| | | | genta | | | | | | | |
| Ex. 11 | Yellow | 0.01 | Cyan | 0.03 | Magenta | 0.25 | Black | 0.25 | 0.04 | 0.12 |
| Ex. 12 | Yellow | 0.2 | Cyan | 0.6 | Magenta | 2 | Black | 2 | 0.1 | 0.3 |
| Ex. 13 | Yellow | 0.04 | Cyan | 0.1 | Magenta | 0.5 | Black | 0.5 | 0.08 | 0.05 |
| Ex. 14 | Yellow | 0.005 | Cyan | 0.005 | Magenta | 0.1 | Black | 0.1 | 0.05 | 0.12 |
| Ex. 15 | Yellow | 0.01 | Cyan | 0.03 | Magenta | 0.25 | Black | 0 | 0.04 | 0.12 |
| Ex. 16 | Yellow | 0.01 | Cyan | 0.03 | Magenta | 0.25 | Black | 0.25 | 0.04 | 0.12 |
| Ex. 17 | Yellow | 0.01 | Cyan | 0.03 | Magenta | 0.25 | Black | 0.25 | 0.04 | 0.12 |
| Ex. 18 | Yellow | 0.01 | Ma- | 0.25 | Cyan | 0.03 | Black | 0.25 | 0.04 | 0.12 |
| | | | genta | | | | | | | |
| Com. | Yellow | 0 | Cyan | 0 | Magenta | 0 | Black | 0 | — | — |
| Ex. 6 | | | | | | | | | | |
| Com. | Yellow | 0 | Cyan | 0 | Magenta | 0 | Black | 0.25 | — | — |
| Ex. 7 | | | | | | | | | | |
| Com. | Yellow | 2 | Cyan | 2 | Magenta | 0 | Black | 0 | — | — |
| Ex. 8 | | | | | | | | | | |
| Com. | Yellow | 2 | Cyan | 2 | Magenta | 0 | Black | 2 | — | — |
| Ex. 9 | | | | | | | | | | |

(6) Evaluation

(6-1) Fixing Strength

Each of the fixed toner images formed on the recording mediums obtained in the Examples 4 to 18 and the Comparative Examples 6 to 9 was rubbed out three times using a sand eraser (“LION 261-11”, Product of LION OFFICE PRODUCTS CORP.) with a pressure loading of 1.5 kgf. Then, the residual rate of the image density of each recording paper was measured by a calorimeter “X-Rite model 404” (X-Rite Incorporated), and the measurement results were evaluated according to the following five criteria.

AA: Residual rate of the image density was 95% or higher

A: Residual rate of the image density was 90% or higher but lower than 95%

B: Residual rate of the image density was 80% or higher but lower than 90%

C: Residual rate of the image density was 70% or higher but lower than 80%

D: Residual rate of the image density was lower than 70%

(6-2) Evaluation of Image Quality (Colors)

In each of the fixed toner images formed on the recording mediums obtained in the Examples 4 to 18 and the Comparative Examples 6 to 9, a color mixture patch of magenta, yellow and cyan and a patch of black were subjected to color measurement using an X-Rite 968, color reproductivity with respect to the fixing patch obtained in the case where no oxidation polymerization accelerator was added (Comparative Example 6) was evaluated according to the following four criteria.

A: There was no difference from the original image (ΔE≦2)

B: There was less difference from the original image (2<ΔE≦3)

C: Slightly different from the color of the original image (3<ΔE<5)

D: Considerably different from the color of the original image (ΔE≧5)

These results are shown in the following TABLE 4.

TABLE 4

Fixing Strength

| | Residual ratio | | |
|---|---|---|---|
| | of image | | Evaluation |
| | density | | of image |
| | [%] | Evaluation | quality |
| Ex. 4 | 84 | B | A |
| Ex. 5 | 91 | A | A |
| Ex. 6 | 87 | B | A |
| Ex. 7 | 86 | B | A |
| Ex. 8 | 87 | B | A |
| Ex. 9 | 88 | B | A |
| Ex. 10 | 82 | B | A |
| Ex. 11 | 96 | AA | A |
| Ex. 12 | 97 | AA | B |
| Ex. 13 | 96 | AA | A |
| Ex. 14 | 93 | A | A |
| Ex. 15 | 94 | A | A |
| Ex. 16 | 97 | AA | A |
| Ex. 17 | 96 | AA | A |
| Ex. 18 | 95 | AA | A |
| Com. Ex. 6 | 61 | D | A |
| Com. Ex. 7 | 72 | C | B |
| Com. Ex. 8 | 93 | A | D |
| Com. Ex. 9 | 94 | A | D |

As is apparent from TABLE 4, each of the Examples 4 to 18 was excellent in the fixing strength and the image quality. In contrast, in each of the Comparative Examples 6 to 9, satisfactory results could not be obtained.

Finally, it is to be noted that the present invention is not limited to the embodiments and the examples described above, and many additions and modifications may be made without departing from the spirit of the present invention which is defined by the following claims.

What is claimed is:

1. An image forming method, comprising:
a developing step for forming a plurality of monochromatic color images using a plurality of liquid developers of different colors;
a transfer step for forming an unfixed color image onto a recording medium; and
a fixing step for fixing the unfixed color image onto the recording medium,
wherein each of the liquid developers is comprised of an insulation liquid containing an unsaturated fatty acid component and toner particles dispersed in the insulation liquid, and wherein the liquid developers include a magenta liquid developer, and the magenta liquid developer contains an oxidation polymerization accelerator which accelerates an oxidation polymerization reaction of the unsaturated fatty acid component in the fixing step.

2. The image forming method as claimed in claim 1, wherein the oxidation polymerization accelerator is colored with red or its similar colors.

3. The image forming method as claimed in claim 1, wherein the liquid developers further include a black liquid developer, a yellow liquid developer and a cyan liquid developer, wherein among the magenta, yellow and cyan liquid developers only the magenta liquid developer contains the oxidation polymerization accelerator.

4. The image forming method as claimed in claim 1, wherein the liquid developers further include a black liquid developer, a yellow liquid developer and a cyan liquid developer, wherein the yellow liquid developer and the cyan liquid developer also contain the oxidation polymerization accelerator, but the magenta liquid developer contains a largest amount of the oxidation polymerization accelerator.

5. The image forming method as claimed in claim 4, wherein when the amount of the oxidation polymerization accelerator contained in the magenta liquid developer with respect to 100 parts by weight of the insulation liquid is defined as X parts by weight and the amount of the oxidation polymerization accelerator contained in the yellow liquid developer with respect to 100 parts by weight of the insulation liquid is defined as Y parts by weight, the relation of Y/X≦0.1 is satisfied.

6. The image forming method as claimed in claim 4, wherein when the amount of the oxidation polymerization accelerator contained in the magenta liquid developer with respect to 100 parts by weight of the insulation liquid is defined as X parts by weight and the amount of the oxidation polymerization accelerator contained in the cyan liquid developer with respect to 100 parts by weight of the insulation liquid is defined as Z parts by weight, the relation of Z/X≦0.4 is satisfied.

7. The image forming method as claimed in claim 1, wherein the amount of the oxidation polymerization accelerator contained in the magenta liquid developer with respect to 100 parts by weight of the insulation liquid is in the range of 0.01 to 2 parts by weight.

8. The image forming method as claimed in claim 1, wherein the insulation liquid contains unsaturated fatty acid glyceride and fatty acid monoester.

9. The liquid developer as claimed in claim 1, wherein the oxidation polymerization accelerator is contained in the liquid developer with being encapsulated.

10. A liquid developer developing apparatus, comprising:
a plurality of developing sections for forming a plurality of monochromatic color images using a plurality of liquid developers of different colors;
an intermediate transfer section to which a plurality of monochromatic color images formed by the developing sections are sequentially transferred to form an intermediate transfer image which is formed by overlaying the transferred monochromatic color images one after another; and
a secondary transfer section for transferring the intermediate transfer image onto a recording medium to form an unfixed image,
wherein each of the liquid developers of the different colors is comprised of an insulation liquid containing an unsaturated fatty acid component and toner particles dispersed in the insulation liquid, and wherein the liquid developers include a magenta liquid developer, and the magenta liquid developer contains an oxidation polymerization accelerator which accelerates an oxidation polymerization reaction of the unsaturated fatty acid component when the transferred imaged is fixed.

11. The developing apparatus using a liquid developer as claimed in claim 10, wherein the plurality of developing sections are composed from a developing section for forming a black monochromatic image and a plurality of color developing sections for forming the plurality of monochromatic color images other than black, wherein among these color developing sections for forming the monochromatic color images the color developing section including the magenta liquid developer is arranged at a position from which the monochromatic color image is formed on the intermediate transfer section at the last.

12. The developing apparatus using a liquid developer as claimed in claim 10, wherein each of the developing sections includes a liquid developer storage for containing the corresponding liquid developer, and the liquid developer storage containing the magenta liquid developer includes a reducing element for reducing the unsaturated fatty acid component which has been oxidized, in which the reducing element is formed of zeolite.

13. An image forming apparatus, comprising:
a plurality of developing sections for forming a plurality of monochromatic color images using a plurality of liquid developers of different colors;
an intermediate transfer section to which a plurality of monochromatic color images formed by the developing sections are sequentially transferred to form an intermediate transfer image which is formed by overlaying the transferred monochromatic color images one after another;
a secondary transfer section for transferring the intermediate transfer image onto a recording medium to form an unfixed image onto the recording medium, and
a fixing device for fixing the unfixed image onto the recording medium,
wherein each of the liquid developers of the different colors is comprised of an insulation liquid containing an unsaturated fatty acid component and toner particles dispersed in the insulation liquid, and wherein the liquid developers include a magenta liquid developer, and the magenta liquid developer contains an oxidation polymerization accelerator which accelerates an oxidation polymerization reaction of the unsaturated fatty acid component when the transferred imaged is fixed.
